(19) United States
(12) Patent Application Publication
(10) Pub. No.: US 2019/0351563 A1
(43) Pub. Date: Nov. 21, 2019

(54) HOLDING DEVICE FOR FOOD

(71) Applicant: KAWASAKI JUKOGYO KABUSHIKI KAISHA, Kobe-shi, Hyogo (JP)

(72) Inventors: Kenji BANDO, Nishinomiya-shi (JP); Kazunori HIRATA, Yao-shi (JP); Keita SASAKI, Akashi-shi (JP); Yasuhiko HASHIMOTO, Kobe-shi (JP)

(73) Assignee: KAWASAKI JUKOGYO KABUSHIKI KAISHA, Kobe-shi, Hyogo (JP)

(21) Appl. No.: 16/466,323

(22) PCT Filed: Dec. 7, 2017
(86) PCT No.: PCT/JP2017/043974

§ 371 Date: Jun. 4, 2019

(30) Foreign Application Priority Data
Dec. 9, 2016 (JP) 2016-238983
Apr. 3, 2017 (JP) 2017-073925

(51) Int. Cl. B25J 15/08; B65G 47/90; B65B 5/06; B65B 35/56

(52) U.S. Cl. CPC B25J 15/08; B65G 47/905; B65G 2201/0202; B65B 35/56; B65B 5/06

(57) ABSTRACT

A holding device for food includes a right hand part configured to hold the food in a first posture where a first surface part is oriented horizontally, and to be changeable the posture of the food from the first posture into a second posture where a second surface part is oriented horizontally, a right arm (food feeding part) configured to sequentially feed the food held in the second posture by the first holding part to a given position, a left hand part (second holding part) configured to hold a plurality of foods fed to the given position in the second posture, the foods being held so as to be laterally piled up in a given direction, and a left arm (food accommodating part) configured to accommodate the plurality of foods held by the left hand part into a given container.

### TECHNICAL FIELD

The present disclosure relates to a holding device for food.

### BACKGROUND ART

Generally, in a production line for food, such as rice balls and sandwiches, the produced foods are packed into a container and shipped to retail stores, such as convenience stores. Therefore, in terms of transportation cost etc., the foods are desirably packed into the container with high accommodation efficiency. However, the packing work is difficult to be automated, and depends on human labor. Such a food is easy to be deformed, and once it is deformed by an external force, it will not resume its original shape even if the external force is removed. Therefore, if the food falls and is deformed by the external force, the commodity value of the food is spoiled by the deformation. As a result, a ratio of nonconforming products increases to deteriorate the work efficiency.

Conventionally, there are devices which can hold a plurality of food. For example, a boxing device disclosed in Patent Document 1 sucks and holds foods (cucumbers) of a front row and a rear row placed in two respective alignment trays by respective suction pads, and supports each food (cucumber) in a posture where a rear end part of the food is slightly inclined downwardly. Then, the front-row food (cucumber) and the rear-row food (cucumber) sucked and held by the each suction pad are overlapped at their longitudinal ends, and are then boxed. Moreover, a boxing device disclosed in Patent Document 2 lifts a plurality of foods (rice balls) upward via a suction unit in a suspending manner, the suspended foods are moved to a given boxing position and lowered, and are then boxed in a box by stopping the suction. In Patent Document 3 as other conventional technology, a robot hand which holds at once a plurality of foods which are flowed through a previous process by a conveying device, such as a belt conveyor, and transfers the foods to a next process is disclosed. This robot hand is provided with a frame elongated in one direction at an upper part, and a plurality of gripper pillars fixed to base plates are suspended below the frame at equal interval. A workpiece gripper is provided to a lower end of each gripper pillar.

### REFERENCE DOCUMENTS OF CONVENTIONAL ART

### Patent Documents

[Patent Document 1] JP1994-071404U
[Patent Document 2] JP2011-251702A
[Patent Document 3] JP2001-198871A

### DESCRIPTION OF THE DISCLOSURE

### Problems to be Solved by the Disclosure

However, the boxing device of Patent Document 1 can hold only two pieces of food (cucumbers) at once. For this reason, if foods, such as rice balls and sandwiches, are packed into a container by using the boxing device, the productivity may be lowered.

The boxing device of Patent Document 2 and the robot hand of Patent Document 3 can hold a plurality (6 pieces) of foods at once. However, they hold the foods in a state where the foods are laterally disposed, and thus, there is a problem that a large workspace is needed for the packing work of the foods.

The present disclosure is made in view of solve the above problems, and one purpose thereof is to improve the efficiency of a packing work of foods within a limited workspace.

### Summary of the Disclosure

In order to achieve the purpose described above, according to one aspect of the present disclosure, a holding device for food includes a first holding part configured to hold the food in a first posture where a given first surface of the food is oriented horizontally, and to be changeable the posture of the food from the first posture into a second posture where a second surface different from the first surface of the food is oriented horizontally, a food feeding part configured to sequentially feed the food held in the second posture to a given position by the first holding part, a second holding part configured to hold a plurality of foods fed to the given position in the second posture, the foods being held so as to be laterally piled up in a given direction, and a food accommodating part configured to accommodate the plurality of foods held by the second holding part into a given container.

According to this structure, the food is first held in the first posture (e.g., a flat posture) where the first surface of the food (e.g., a triangular surface of a triangular rice ball) is oriented horizontally. Next, the posture of the food is changed from the first posture into the second posture (a standing posture) where the second surface of the food (e.g., a side surface of the triangular rice ball) is oriented horizontally. Then, the food held in the second posture is sequentially fed to the given position. The plurality of foods fed to the given position in the second posture are held in the piled-up manner. At the end, the plurality of held foods are accommodated into the given container. Thus, the efficiency of the packing work of the foods is improved, even within a limited workspace.

The first holding part may include a base part, a rotary joint having a horizontal rotation axis, a tip-end part rotatably coupled to the base part via the rotary joint, and one or more holding heads, provided to the tip-end part and configured to hold the food.

According to this structure, the food in the first posture is held by the holding head provided to the tip-end part of the first holding part, and the posture of the food can be changed from the first posture into the second posture by rotating the tip-end part via the rotary joint, for example, by 90 degrees with respect to the base part.

The holding head may be a suction head configured to suck and hold the first surface of the food, and the first holding part may further include a support member, provided to the tip-end part, and configured to support the food sucked by the suction head by contacting the second surface of the food.

According to this structure, a wrapping portion of the food is sucked and held by the suction head, and a main part of the food is supported by the supporting member. Thus, it is easy to maintain a stable posture of the food when changing the posture of the food.

The second holding part may have a plurality of pairs of holding members configured to hold the respective foods laterally piled up in the second posture at the given position.

According to this structure, the plurality of foods are collectively held efficiently.

The second holding part may further have actuator members configured to drive the respective pairs of holding members so that a mutual angle of each of the pairs of holding members becomes one of a given first angle at which the pair of holding members are holdable of the food by pinching the food from both sides, and a given second angle that is 180 degrees or larger, at which the pair of holding members are releasable of the food.

According to this structure, since each pair of holding members are controlled before and after the holding operation of the food so that the mutual angle becomes 180 degrees or more, it is easy to check a state of the food visually or by a sensor. Moreover, since the opening-and-closing angle only has the two values (e.g., 60 degrees and 180 degrees), a complicated control is not required.

The holding device may further include a controller configured to output a hold command or a release command to be the first angle or the second angle to the actuator member. When evacuating the second holding part which accommodated the plurality of food in the given container out of the given container, the controller may switch the output from the hold command to the release command, and switch the output from the release command to the hold command at a timing where the mutual angle of the pair of holding members is larger than the first angle, and does not exceed a third given angle smaller than the second angle.

According to this structure, the control part controls the mutual angle of each pair of holding members during the evacuation operation of the second holding part by controlling an output timing of the control command to the actuator member. Thus, it can be avoided that, during the evacuation operation of the second holding part, the holding member collides with an inner wall of the given container or an adjacent food.

The holding device may further include a sheet disposed at the given position. The sheet may have convex parts lined up in the given direction, in a cross-sectional view in the given direction, so as to support the respective foods lined up in the given direction in the second posture. According to this structure, the posture (second posture) of each food on the sheet can be stabilized by having the plurality of convex parts. Therefore, it is easy to hold the plurality of foods piled up in the given direction.

Note that the sheet may have steps provided, in a cross-sectional view in the given direction, so as to incline the foods in the given direction, while supporting the respective foods lined up in the given direction in the second posture.

The food may have the first surface and a second surface perpendicular to the first surface, and the first posture may be a posture in which the first surface of the food is oriented downwardly, and the second posture may be a posture in which the second surface of the food is oriented downwardly. Note that the phrase “the first surface and the second surface are perpendicular to each other” as used herein permits a slight inclination caused by the surface of the food or wrapping, without being limited to a strict perpendicularity. The food may be, for example, a handmade rice ball of a triangular shape having triangular first surfaces and rectangular second surfaces.

Before shipment of the foods, a foreign matter inspection of the foods is obligated for the safety of the foods. Generally, since X-rays are emitted to the food from above in an inspection device, if the triangular handmade rice ball is used, a flat posture where the triangular surface faces downwardly is suitable. According to this structure, for example, the food passes through the inspection device, while being conveyed by a conveyor in a production line in the flat posture (first posture) where the triangular surface of the food faces downwardly, and the plurality of foods can then be collectively packed in the standing posture (second posture) where the rectangular surface of the food faces downwardly by the holding device for the food.

The holding device may be configured by a robot including a first arm having the first holding part at a tip end thereof, and a second arm having the second holding part at a tip end thereof.

According to this structure, the packing work of the foods is realized by a dual-arm robot.

According to another aspect of the present disclosure, an operating method of a holding device for food is provided. The holding device includes a first holding part configured to hold the food in a first posture where a given first surface of the food is oriented horizontally, and to be changeable the posture of the food from the first posture into a second posture where a second surface different from the first surface of the food is oriented horizontally, a food feeding part configured to sequentially feed the food held in the second posture to a given position by the first holding part, a second holding part configured to hold a plurality of foods fed to the given position in the second posture, the foods being held so as to be laterally piled up in a given direction, and a food accommodating part configured to accommodate the plurality of foods held by the second holding part into a given container. When an up-and-down direction of the holding device is defined as a first direction, the given direction is defined as a second direction, and a direction perpendicular to both the first direction and the second direction is defined as a third direction, the method includes (A) operating the food accommodating part to move the second holding part in the third direction, while inclining the holding part with respect to the second direction, and after the (A), (B) operating the food accommodating part to rotate the second holding part so as to be parallel to the second direction, and accommodate a second food group that is a plurality of foods held by the second holding part into the given container so as to be adjacent in the second direction to a first food group that is a plurality of foods accommodated in the given container.

According to still another aspect of the present disclosure, an operating method of a holding device for food is provided. The holding device includes a first holding part configured to hold the food in a first posture where a given first surface of the food is oriented horizontally, and to be changeable the posture of the food from the first posture into a second posture where a second surface different from the first surface of the food is oriented horizontally, a food feeding part configured to sequentially feed the food held in the second posture to a given position by the first holding part, a second holding part configured to hold a plurality of foods fed to the given position in the second posture, the foods being held so as to be laterally piled up in a given direction, and a food accommodating part configured to accommodate the plurality of foods held by the second holding part into a given container. When an up-and-down direction of the holding device is defined as a first direction, the given direction is defined as a second direction, and a direction perpendicular to both the first direction and the second direction is defined as a third direction, the method includes (A1) operating the food accommodating part to move the second holding part in the third direction, while pivoting the second holding part about the second direction, and after the (A1), (B) operating the food accommodating part to rotate the second holding part so as to be parallel to the second direction, and accommodate a second food group that is a plurality of foods held by the second holding part into the given container so as to be adjacent in the second direction to a first food group that is a plurality of foods accommodated in the given container.

Further, in the operating method of the holding device for food according to the present disclosure, the (B) may include (B1) operating the food accommodating part to rotate the second holding part so as to become parallel to the second direction, and after the (B1), (B2) operating the food accommodating part to move the second holding part in the third direction.

Further, the operating method of the holding device for food according to the present disclosure may further include (C) operating the food accommodating part to accommodate the second food group into the given container on one end side in the third direction so as to be adjacent in the second direction to the first food group, and after the (C), (D) operating the food accommodating part to accommodate the second food group into the given container on the other end side in the third direction.

Further, the operating method of the holding device for food according to the present disclosure may further include (E) operating the food accommodating part to alternately perform the accommodation into the given container at the one end side in the third direction and the accommodation into the given container at the other end side in the third direction.

Further, the operating method of the holding device for food according to the present disclosure may further include (F) operating the food accommodating part to accommodate the second food group into the given container from the one end side to the other end side in the third direction.

Further, the operating method of the holding device for food according to the present disclosure may further include (G) operating the food accommodating part to release the holding of at least one food of the second food group held by the second holding part, after the (G), (H) operating the food accommodating part to move the second holding part in the second direction, and after the (H), (I) operating the food accommodating part to release the holding of the remaining food held by the second holding part.

Further, in the operating method of the holding device for food according to the present disclosure, in the (H), the food accommodating part may move the second holding part in the second direction so that the released food is separated from the first food group.

According to another aspect of the present disclosure, an operating method of a holding device for food is provided. The holding device includes a holding part configured to hold a plurality of foods fed to a given position so as to be laterally piled up in a given direction, and a food accommodating part configured to accommodate the plurality of foods held by the holding part into a given container. When an up-and-down direction of the holding device is defined as a first direction, the given direction is defined as a second direction, and a direction perpendicular to both the first direction and the second direction is defined as a third direction, the method includes (A) operating the food accommodating part to move the holding part in the third direction, while inclining the holding part with respect to the second direction, and after the (A), (B) operating the food accommodating part to rotate the holding part so as to be parallel to the second direction, and accommodate a second food group that is a plurality of foods held by the holding part into the given container so as to be adjacent in the second direction to a first food group that is a plurality of foods accommodated in the given container.

According to still another aspect of the present disclosure, an operating method of a holding device for food is provided. The holding device includes a holding part configured to hold a plurality of foods fed to a given position so as to be laterally piled up in a given direction, and a food accommodating part configured to accommodate the plurality of foods held by the holding part into a given container. When an up-and-down direction of the holding device is defined as a first direction, the given direction is defined as a second direction, and a direction perpendicular to both the first direction and the second direction is defined as a third direction, the method includes (A1) operating the food accommodating part to move the second holding part in the third direction, while pivoting the holding part about the second direction, and after the (A1), (B) operating the food accommodating part to rotate the second holding part so as to be parallel to the second direction, and accommodate a second food group that is a plurality of foods held by the second holding part into the given container so as to be adjacent in the second direction to a first food group that is a plurality of foods accommodated in the given container.

Further, in the operating method of the holding device for food according to the present disclosure, the (B) may include (B1) operating the food accommodating part to rotate the holding part so as to become parallel to the second direction, and after the (B1), (B2) operating the food accommodating part to move the holding part in the third direction.

Further, the operating method of the holding device for food according to the present disclosure may further include (C) operating the food accommodating part to accommodate the second food group into the given container on one end side in the third direction so as to be adjacent in the second direction to the first food group, and after the (C), (D) operating the food accommodating part to accommodate the second food group into the given container on the other end side in the third direction.

Further, the operating method of the holding device for food according to the present disclosure may further include (E) operating the food accommodating part to alternately perform the accommodation into the given container at the one end side in the third direction and the accommodation into the given container at the other end side in the third direction.

Further, the operating method of the holding device for food according to the present disclosure may further include (F) operating the food accommodating part to accommodate the second food group into the given container from the one end side to the other end side in the third direction.

Further, in the operating method of the holding device for food according to the present disclosure, the holding part may have a plurality of pairs of holding members configured to hold the respective foods. The method may further include (G) operating the food accommodating part to release the holding of at least one food of the second food group held by the holding part, after the (G), (H) operating the food accommodating part to move the holding part in the second direction, and after the (H), (I) operating the food accommodating part to release the holding of the remaining food held by the holding part.

Further, in the operating method of the holding device for food according to the present disclosure, in the (H), the food accommodating part may move the holding part in the second direction so that the released food is separated from the first food group.

### Effect of the Disclosure

The present disclosure has the structure described above, and can realize the improvement of the efficiency of the packing work of the foods within the limited workspace.

### BRIEF DESCRIPTION OF DRAWINGS

FIG. 1 is a plan view schematically illustrating the entire structure of a holding device for food according to Embodiment 1.

FIG. 2 is a perspective view schematically illustrating food in FIG. 1.

FIG. 3 is a front view schematically illustrating the entire structure of one example of a robot in FIG. 1.

FIG. 4A is a view illustrating a structure of a hand part (first holding part) of the robot in FIG. 3.

FIG. 4B is a view illustrating the structure of the hand part (first holding part) of the robot in FIG. 3.

FIG. 5A is a view illustrating a structure of a hand part (second holding part) of the robot in FIG. 3.

FIG. 5B is a view illustrating the structure of the hand part (second holding part) of the robot in FIG. 3.

FIG. 6 is a functional block diagram schematically illustrating a configuration of a control device of the robot in FIG. 3.

FIG. 7 is a perspective view illustrating a first holding operation of food.

FIG. 8 is a perspective view illustrating a second holding operation of food.

FIG. 9 is a perspective view illustrating a third holding operation of food.

FIG. 10 is a perspective view illustrating a fourth holding operation of food.

FIG. 11 is a schematic view illustrating one example of a packing operation of the food into a tray by the holding device of Embodiment 1.

FIG. 12 is a schematic view illustrating one example of the packing operation of the food into the tray by the holding device of Embodiment 1.

FIG. 13 is a schematic view illustrating one example of the packing operation of the food into the tray by the holding device of Embodiment 1.

FIG. 14 is a schematic view illustrating one example of the packing operation of the food into the tray by the holding device of Embodiment 1.

FIG. 15 is a schematic view illustrating another example of the packing operation of the food into the tray by the holding device of Embodiment 1.

FIG. 16 is a schematic view illustrating another example of the packing operation of the food into the tray by the holding device of Embodiment 1.

FIG. 17 is a schematic view illustrating another example of the packing operation of the food into the tray by the holding device of Embodiment 1.

FIG. 18 is a schematic view illustrating another example of the packing operation of the food into the tray by the holding device of Embodiment 1.

FIG. 19 is a schematic view illustrating an outline structure of a holding device of Embodiment 2.

FIG. 20 is a schematic view illustrating an outline structure of a holding device of Embodiment 3.

FIG. 21A is a view illustrating another structure of the hand part (first holding part).

FIG. 21B is a view illustrating another structure of the hand part (first holding part).

FIG. 22A is a view illustrating another structure of the hand part (second holding part).

FIG. 22B is a view illustrating another structure of the hand part (second holding part).

FIG. 23 is a view illustrating an evacuation operation of the hand part in FIGS. 22A and 22B.

FIG. 24 is a timing chart illustrating one example of a control command of the hand part and an angle of a hand, during operation of FIG. 23.

FIG. 25A is one example of a cross-sectional view of a sheet disposed on a workbench of FIG. 1.

FIG. 25B is another example of the cross-sectional view of the sheet disposed on the workbench of FIG. 1.

FIG. 26 is a view illustrating another structure of the hand part (first holding part).

### MODES FOR CARRYING OUT THE DISCLOSURE

Hereinafter, desirable embodiments will be described with reference to the drawings. Note that, in the following, the same reference characters are assigned to the same or corresponding components throughout the drawings to omit redundant description. Moreover, each component is illustrated schematically in the drawings in order to facilitate understandings. Further, a direction in which a pair of arms extend is referred to as a “left-and-right direction,” a direction parallel to an axial center of a base shaft is referred to as an “up-and-down direction,” and a direction perpendicular to the left-and-right direction and the up-and-down direction is referred to as a “front-and-rear direction.”

### Embodiment 1

### [Structure of Holding Device]

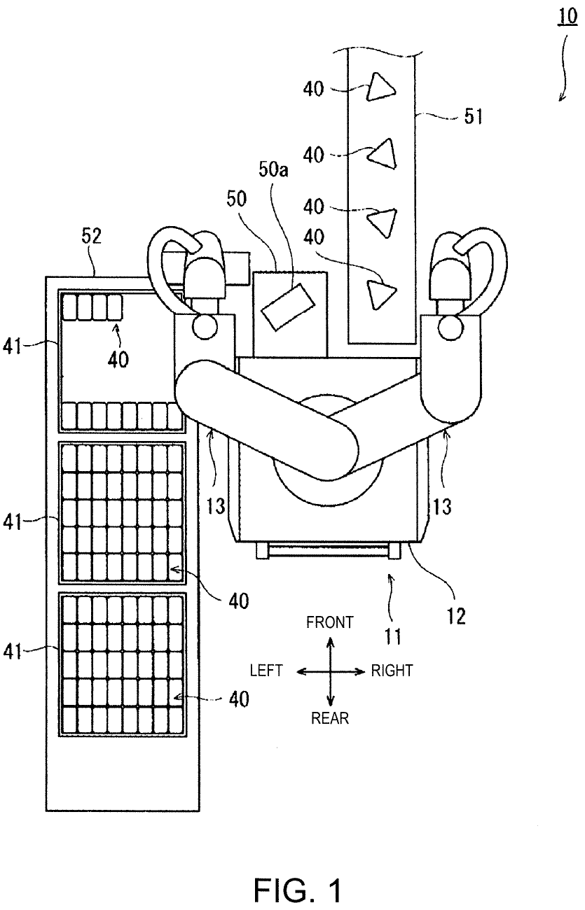

FIG. 1 is a plan view schematically illustrating the entire structure of a holding device 10 for food 40 according to Embodiment 1.

As illustrated in FIG. 1, the holding device 10 for the food 40 is used for a packing work of a plurality of foods 40 into a tray 41. In this embodiment, a case where the holding device 10 for the food 40 according to the present disclosure is comprised of a robot 11 will be described.

The robot 11 is a dual-arm robot having a pair of robot arms 13 supported by a base 12. Note that the holding device 10 for the food 40 is not limited to this configuration comprised of the robot 11. Note that, although, as the robot 11, a horizontal articulated dual-arm robot will be described, other robots, such as a horizontal articulated or a vertical articulated robot, may also be employed. The robot 11 can be installed within a limited space corresponding to one person (e.g., 610 mm×620 mm)

A workbench 50 for the robot 11 is disposed in front of, and on the left side of the robot 11. The workbench 50 has a substantially square shape in the plan view, and is attached to a front surface of the base 12. A sheet 50a having a rectangular shape in the plan view is disposed at a given position on the workbench 50. A first belt conveyor 51 is disposed in front of the robot 11, and a second belt conveyor 52 is disposed at the left side of the robot 11.

In Embodiment 1, a “workspace” of the pair of robot arms 13 is an area, in the plan view, which covers the workbench 50, a part of the first belt conveyor 51 on the robot 11 side, and the second belt conveyor 52. The first belt conveyor 51 is a device which transfers the food 40 from a location forward of the robot 11 to a closer location of the robot 11, and extends in the front-and-rear direction. The second belt conveyor 52 is a device which transfers the tray 41 from a location on the left side of the robot 11 to a location rearward, and extends in the front-and-rear direction. Moreover, although the tray 41 is a container which can accommodate 40 pieces of the foods (8 columns×5 rows) 40 in this example, the storage capacity of the tray 41 is not limited to this size. Moreover, other containers, which open upwardly, may also be used.

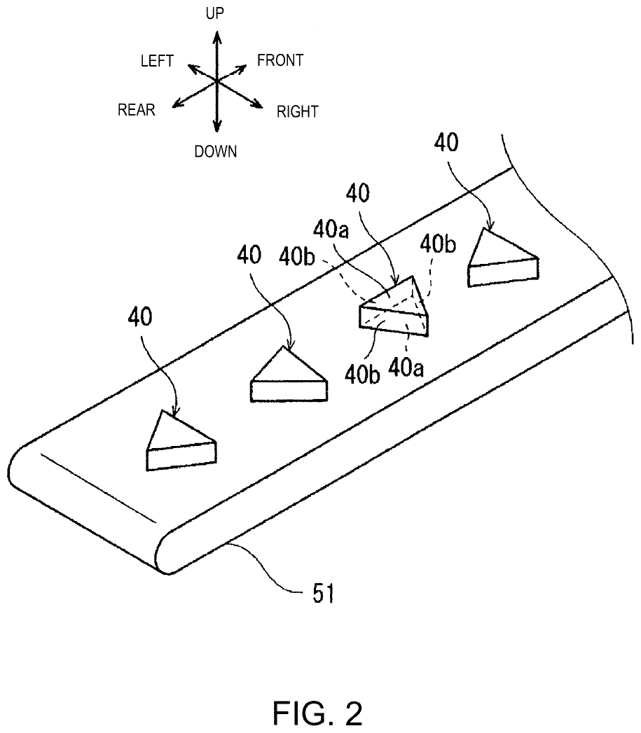

Moreover, the food 40 is food having a constant shape, and may be, for example, a rice ball or a sandwich. Here, a structure of the food 40 will be described in detail with reference to FIG. 2.

FIG. 2 is a perspective view schematically illustrating the food 40 in FIG. 1.

As illustrated in FIG. 2, each food 40 has first surface parts 40a and second surface parts 40b perpendicular to the first surface parts 40a. The food 40 in this embodiment is a triangular rice ball wrapped with a film The first surface parts 40a of the food 40 are comprised of two mutually-parallel triangular planes. The second surface parts 40b of the food 40 are comprised of three rectangular planes provided to three sides surrounding the perimeter of the first surface parts 40a.

Note that the phrase “the first surface part 40a and the second surface part 40b are perpendicular to each other,” or “the first surface parts 40a are parallel to each other” does not limit the mutual angle to the strict perpendicularity or parallelism, but permits a slight inclination caused by the surface of the food 40 or the wrapping. Although the rice ball wrapped with the film typically projects the film from the upper part thereof in order to facilitate opening of the film, illustration of the film in the upper part is omitted.

In this embodiment, the food 40 is conveyed on the first belt conveyor 51 in a first posture where the first surface part 40a is oriented horizontally. The first posture is the flat posture where the triangular-shaped first surface part 40a of the food 40 is oriented downwardly. Generally, before the shipment of the foods 40, a foreign substance inspection is conducted for securing the safety. For example, in the X-ray inspection, since X-rays are emitted to the food 40 from above, the flat posture is a suitable posture for the food 40. In Embodiment 1, the food 40 is conveyed in the flat posture on the first belt conveyor 51 and passes through a location below an inspection device (not illustrated). Then, the posture of the food 40 is changed from the first posture into a second posture where the second surface part 40b is oriented horizontally, by the holding device 10 for the food 40 as will be described later. The second posture is the standing posture where the rectangular-shaped second surface part 40b of the food 40 is oriented downwardly.

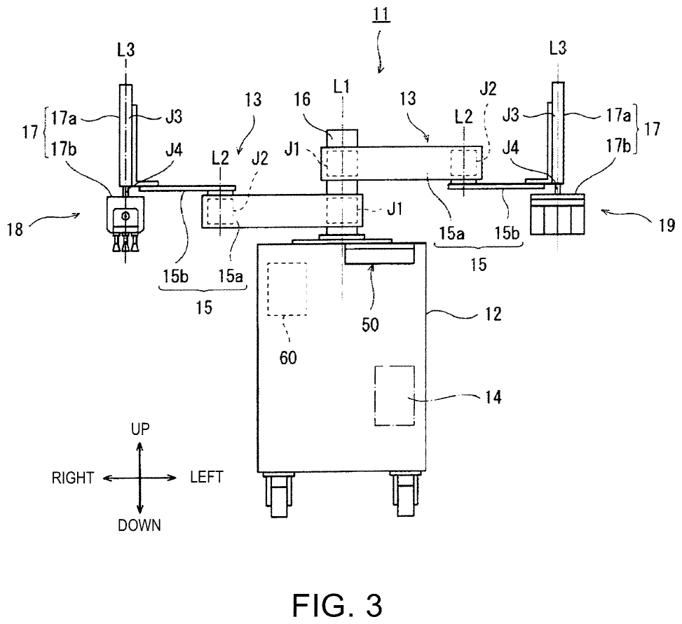

FIG. 3 is a front view schematically illustrating the entire structure of one example of the robot 11.

As illustrated in FIG. 3, the robot 11 includes the base 12 fixed to a carriage, a pair of robot arms (hereinafter, may simply be referred to as the “arms”) 13 supported by the base 12, and a control device 14 and a vacuum generator 60 which are accommodated in the base 12. The vacuum generator 60 is, for example, a device which generates negative pressure at suction heads 22 described later, such as a vacuum pump or CONVUM®. Each arm 13 is a horizontal articulated robot arm configured to be movable with respect to the base 12, and is provided with an arm part 15, a wrist part 17, and a hand part 18 or 19. Note that the right arm 13 and the left arm 13 may have substantially the same structure. Moreover, the right arm 13 and the left arm 13 are capable of operating independently or collaboratively.

In this example, each arm part 15 is comprised of a first link 15a and a second link 15b. The first link 15a is coupled to a base shaft 16 fixed to an upper surface of the base 12 via a rotary joint J1, and is rotatable about a rotation axis L1 passing through the axial center of the base shaft 16. The second link 15b which is coupled to a tip end of the first link 15a via a rotary joint J2, and is rotatable about a rotation axis L2 defined at the tip end of the first link 15a.

The wrist part 17 is comprised of an elevating part 17a and a rotary part 17b. The elevating part 17a is coupled to a tip end of the second link 15b via a linear-motion joint J3, and is capable of ascending and descending with respect to the second link 15b. The rotary part 17b is coupled to a lower end of the elevating part 17a via a rotary joint J4, and is rotatable about a rotation axis L3 defined at a lower end of the elevating part 17a.

The right hand part 18 and the left hand part 19 are each coupled to the rotary part 17b of the wrist part 17. The right hand part 18 is provided to a tip end of the right arm 13, and the left hand part 19 is provided to a tip end of the left arm 13. Note that the right hand part 18 corresponds to a “first holding part” of the present disclosure, and the left hand part 19 corresponds to a “second holding part” of the present disclosure. Moreover, the right arm 13 corresponds to a “food feeding part” of the present disclosure, and the left arm 13 corresponds to a “food accommodating part” of the present disclosure.

Each arm 13 having the above structure has joints J1-J4. Each arm 13 is provided, corresponding to the joints J1-J4, with servo motors (not illustrated) for driving the joints, and encoders (not illustrated) which detect rotational angles of the servo motors. Moreover, the rotation axes L1 of the first links 15a of the two arms 13 are located on the same straight line, and the first link 15a of one of the arms 13 and the first link 15a of the other arm 13 are disposed with a height difference therebetween.

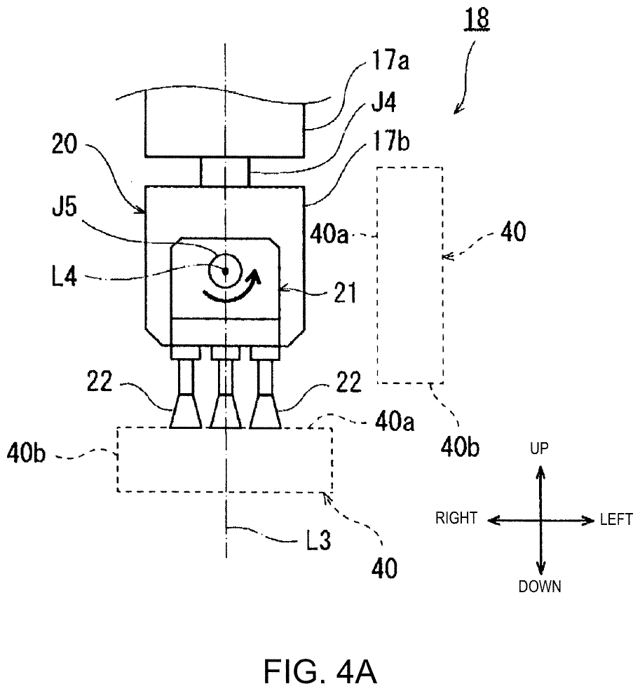

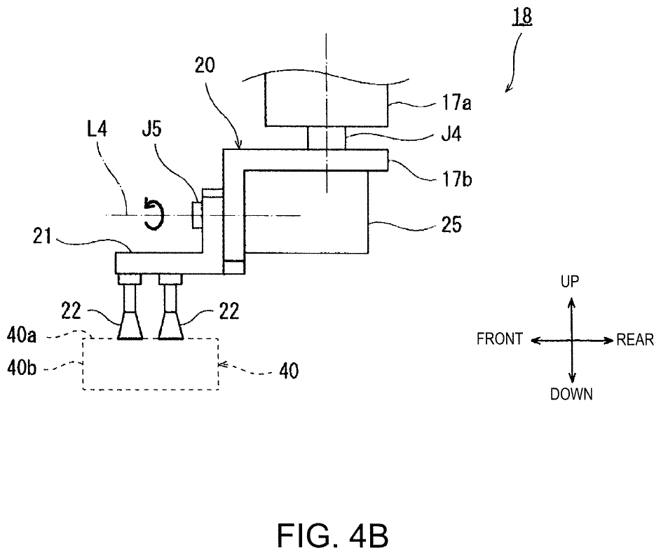

FIGS. 4A and 4B are a front view and a side view, respectively, illustrating a structure of the right hand part 18 (first holding part) in FIG. 3. The right hand part 18 is constructed to hold the food 40 in the first posture where the first surface part 40a is oriented horizontally, and to be changeable of the posture of the food 40 from the first posture into the second posture where the second surface part 40b is oriented horizontally. The right hand part 18 has a base part 20 including the rotary part 17b of the wrist part 17, a rotary joint J5 having a horizontal rotation axis L4, a tip-end part 21 rotatably coupled to the base part 20, and the suction heads 22 which are provided to the tip-end part 21 and suck the food 40 (first surface part 40a).

The base part 20 is coupled to the elevating part 17a of the wrist part 17 via the rotary joint J4, and is coupled to the tip-end part 21 via the rotary joint J5. The base part 20 is bent into a substantially L-shape in the side view (see FIG. 4B). The base part 20 has an actuator 25 of the rotary joint J5 inside the L-shape member.

The tip-end part 21 is coupled to the base part 20 via the rotary joint J5, to which the suction heads 22 are attached. The tip-end part 21 is bent into a substantially L-shape in the side view (see FIG. 4B). In this embodiment, three suction heads 22 having the same length are provided at different locations in a back side of a tip-end surface 22b. Contact surfaces of the three suction heads 22 are constructed so as to contact the first surface part 40a of the food 40 at three points which are not located on a straight line in the first surface part 40a. As illustrated in the drawings, the posture of the contact surfaces of the suction heads 22 where the contact surfaces face downwardly is referred to as a reference posture of the suction heads 22. The suction heads 22 are connected with the vacuum generator 60 (see FIG. 1) via piping (not illustrated). The piping is provided, for example, with an on-off valve (not illustrated). By opening and closing the piping by the on-off valve, suction and release of the suction heads 22 are performed.

Thus, the food 40 in the first posture is sucked and held by the suction heads 22 provided to the tip-end part 21 of the right hand part 18, and the food 40 can be changed in the posture from the first posture into the second posture by rotating the tip-end part 21 via the rotary joint J5 by 90 degrees with respect to the base part 20.

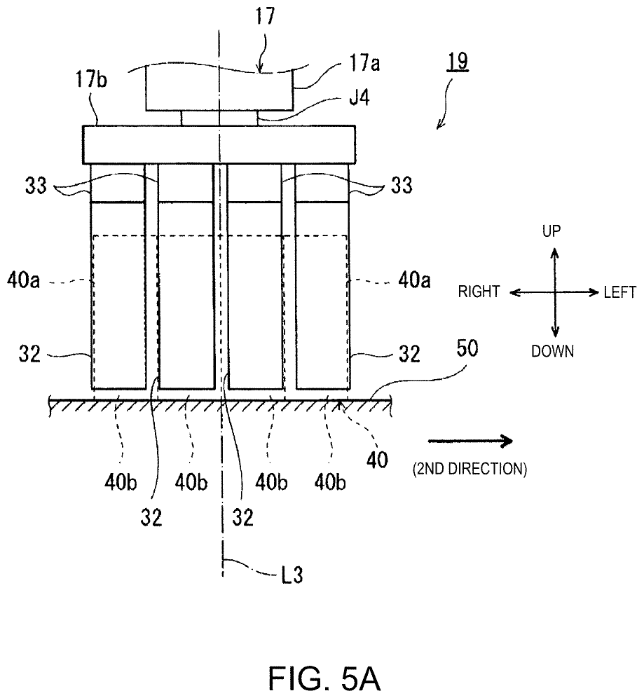

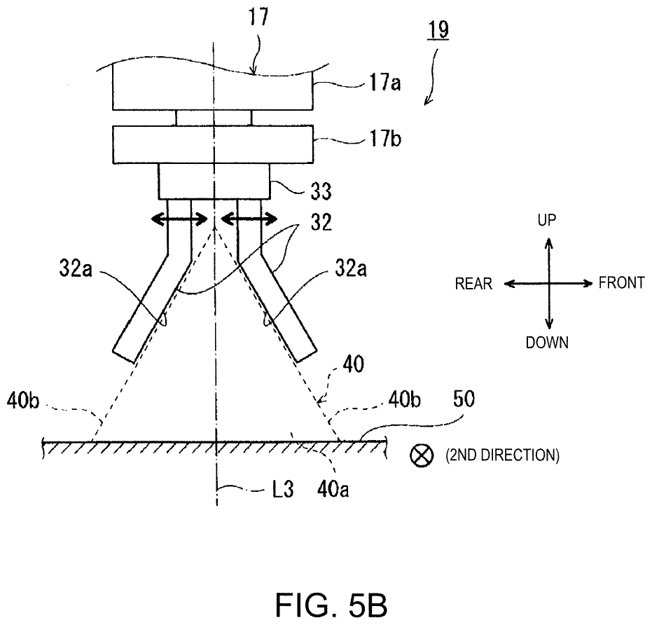

FIGS. 5A and 5B are a front view and a side view, respectively, illustrating a structure of the left hand part 19 (second holding part; holding part) in FIG. 3.

As illustrated in FIGS. 5A and 5B, the left hand part 19 is constructed to hold four pieces of food 40 in a laterally piled-up manner so that the first surface part 40a of each food 40 fed in the second posture at the given position on the workbench 50 face in a second direction which is a given direction.

In FIGS. 5A and 5B, the second direction is the left-and-right direction. Note that, in the following description, the up-and-down direction of the holding device 10 for the food 40 is defined as the first direction, and the front-and-rear direction which is a direction perpendicular to both the first and second directions is defined as a third direction.

The left hand part 19 has four pairs of holding members 32 lined up in the second direction, and four actuator members 33 each capable of independently driving the respective pairs of holding members 32. The rotary part 17b of the wrist part 17 extends in the horizontal direction perpendicular to the rotation axis L3 in the front view. Each holding member 32 is connected with the rotary part 17b of the wrist part 17 via the respective actuator member 33.

At the given position on the workbench 50, each pair of holding members 32 is constructed to hold each of the foods 40 laterally piled up in the second posture where the first surface part 40a faces in the second direction.

In Embodiment 1, each pair of holding members 32 is constructed to pinch the second surface parts 40b of the food 40 from both sides. Each holding member 32 has contact surfaces 32a each having the shape corresponding to the inclination of the second surface part 40b of the food 40, and contacting the food 40. The holding member 32 is, for example, a rectangular flat-plate shape, and has two opposite flat principal surfaces. One of the principal surfaces is the contact surface 32a which contacts the food 40 held by the holding members 32. The holding member 32 may be formed by, for example, a resin plate or a metal plate. In this embodiment, since the triangular rice ball is used as the food 40, each pair of holding members 32 is provided so as to reduce the mutual distance toward upper end parts thereof, and is formed in a mountain shape which spreads downwardly (an inverted V-shape).

Each actuator member 33 drives the corresponding pair of holding members 32. The actuator member 33 is connected to an actuator (not illustrated) etc. The actuator is connected to an upper end side of the pair of holding members 32 so that the mutual distance of the pair of holding members 32 changes by linearly moving the actuator member 33. By the actuator member 33, the pair of holding members 32 reduces the mutual distance to pinch and hold one piece of food 40. In this embodiment, the pair of holding members 32 are controlled so that the mutual distance is widened and narrowed in the arrow direction in FIG. 5B, while the mutual angle is maintained at an angle corresponding to the inclinations of the second surface parts 40b of the food 40 (about 60 degrees). Although in Embodiment 1 the food 40 is held by the frictional force caused by contacting the contact surfaces 32a of the holding members 32 with the second surface parts 40b of the food 40, suction port(s) may be formed in the contact surface(s) 32a to hold the food 40 by the suction force.

Note that Embodiment 1 is configured to form a gap in the upper parts of the left and right holding members 32 when holding the food 40. Thus, the holding members 32 do not touch the film in the upper part of the rice ball (food 40). Typically, in the rice ball wrapped with the film, the film in the upper part is made easier to be torn by perforations etc. formed in order to facilitate an easier opening of the film and, thus, the above structure of the holding members 32 will not accidentally open food 40 nor damage the food 40.

Moreover, although Embodiment 1 adopts a form in which the left hand part 19 has the plurality (here, four pairs) of holding members 32, and a plurality of 40 are held by each pair of holding members 32, the present disclosure is not limited to this structure. The left hand part 19 may have a pair of holding members 32 which hold the plurality of 40.

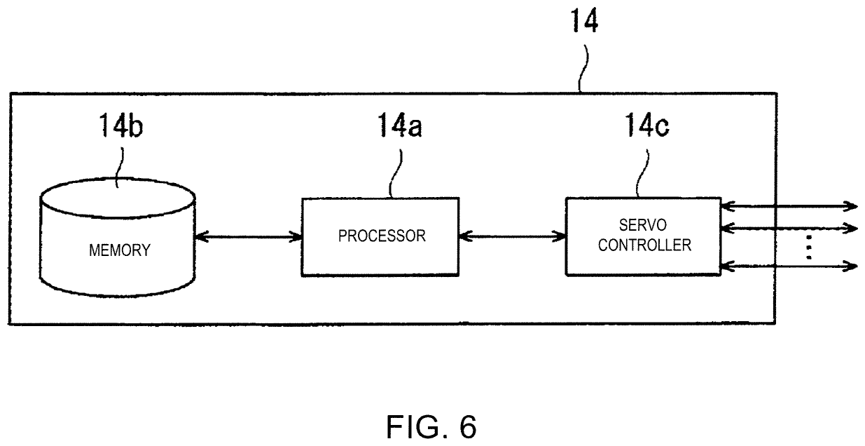

FIG. 6 is a functional block diagram schematically illustrating a configuration of the control device 14 of the robot 11 in FIG. 3.

As illustrated in FIG. 6, the control device (controller) 14 includes a processor 14a, such as a CPU, a memory 14b, such as a ROM and/or RAM, and a servo controller 14c. The control device 14 is a robot controller provided with a computer, such as a microcontroller. Note that the control device 14 may be comprised of a single control device 14 which carries out a centralized control, or may be comprised of a plurality of control devices 14 which collaboratively carry out a distributed control.

The memory 14b stores information on a basic program which functions as the robot controller, various fixed data, etc. The processor 14a controls various operations of the robot 11 by reading and executing software, such as the basic program, stored in the memory 14b. That is, the processor 14a generates a control command for the robot 11, and then outputs it to the servo controller 14c. Based on the control command generated by the processor 14a, the servo controller 14c controls the driving of the servo motors corresponding to the joints J1-J5 etc. of each arm 13 of the robot 11.

Note that, although Embodiment 1 adopts a form in which the memory 14b is disposed inside the control device 14, it may adopt a form in which the memory 14b is provided separately from the control device 14, without being limited to the above structure.

The control device 14 also controls operation of the vacuum generator 60 (see FIG. 1), and the opening and closing of the on-off valve. When opening and closing the on-off valve to open and close the piping, the suction and release of the suction heads 22 are performed.

### [Operation of Holding Device]

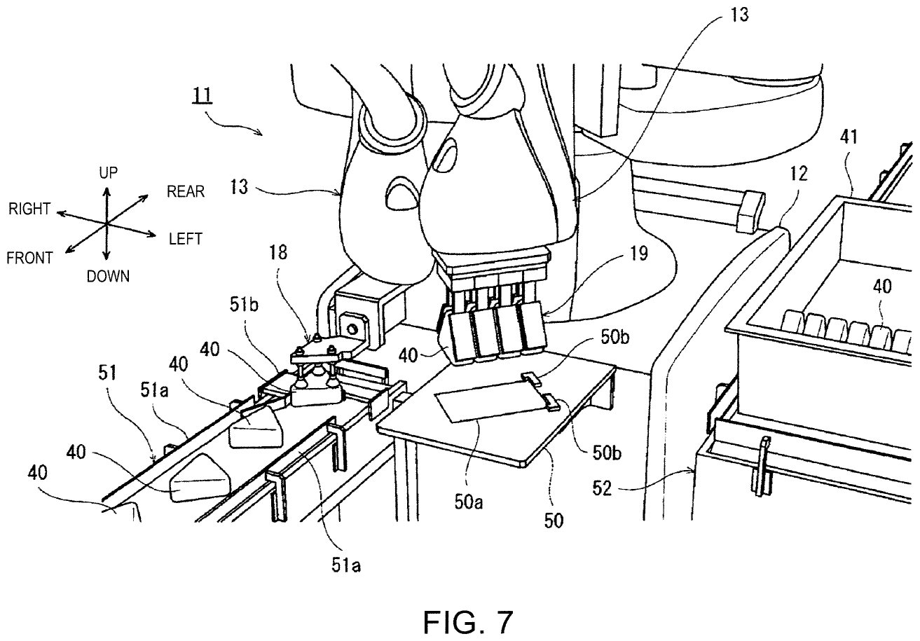

Next, a holding operation of the food(s) 40 in Embodiment 1 will be described with reference to FIGS. 7 to 10. Note that the following operation is executed by the processor 14a of the control device 14 reading the program stored in the memory 14b.

FIGS. 7 to 10 are schematic views illustrating one example of the holding operation of the food(s) 40 executed by the holding device 10 of Embodiment 1.

As illustrated in FIGS. 7 to 10, in this embodiment, each food 40 is conveyed on the first belt conveyor 51 in the first posture where the first surface part 40a is oriented horizontally. A pair of side walls 51a is provided at both sides of the first belt conveyor 51 in the conveyance direction. The pair of side walls 51a regulates a flow of the conveying objects. A stop 51b is provided at an end of the first belt conveyor 51. The stop 51b blocks the flow of the food 40 being conveyed in the first posture. In a plan view, the rectangular sheet 50a and a pair of supporting members 50b which support the food 40 are disposed at given positions of the workbench 50 attached to the front side of the base 12.

First, as illustrated in FIG. 7, the control device 14 controls the operation of the right arm 13 to align the right hand part 18 (the position of the wrist part 17) with an approximate location above the stop 51b at the end of the first belt conveyor 51. Then, the control device 14 lowers the right hand part 18 (the elevating part 17a of the wrist part 17) while the suction heads 22 are set in the reference posture until the contact surfaces of the suction heads 22 contact to the first surface part 40a of the food 40 on the first belt conveyor 51. Thus, the suction heads 22 suck and hold the food 40 in the first posture.

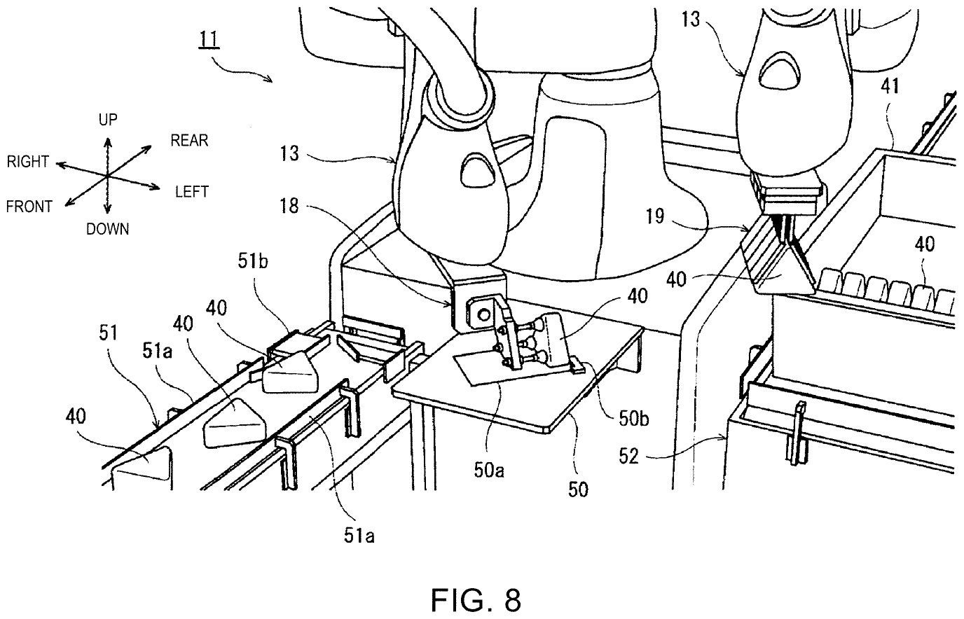

Next, as illustrated in FIG. 8, the control device 14 controls the operation of the right arm 13 to rotate the tip-end part 21 of the right hand part 18 via the rotary joint J5 about the rotation axis L4 by 90 degrees with respect to the base part 20. Thus, the suction heads 22 rotate by 90 degrees from the reference posture. The posture of the food 40 which is sucked and held by the suction heads 22 in the first posture is changed from the first posture into the second posture. Then, the control device 14 controls the operation of the right arm 13 to feed the food 40 held in the second posture by the right hand part 18 to a position on the sheet 50a placed on the workbench 50. By repeating the above operations, four pieces of food 40 are sequentially fed to respective positions on the sheet 50a placed on the workbench 50.

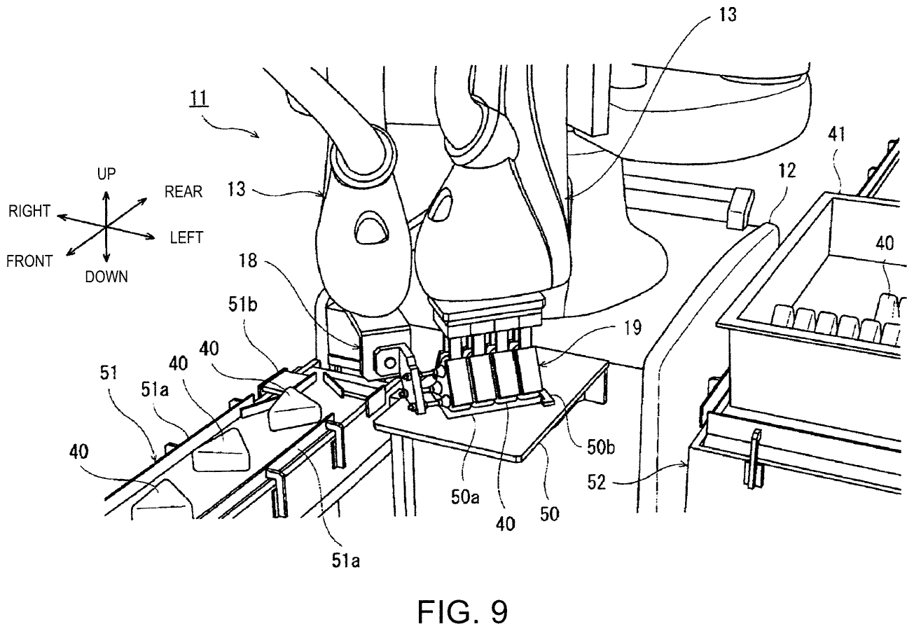

Next, as illustrated in FIG. 9, the control device 14 controls the operation of the left arm 13 to hold four pieces of food 40 in the laterally piled-up manner where the first surface part 40a of each food 40 fed in the second posture by the left hand part 19 to the corresponding position on the sheet 50a placed on the workbench 50 faces in a given direction (second direction).

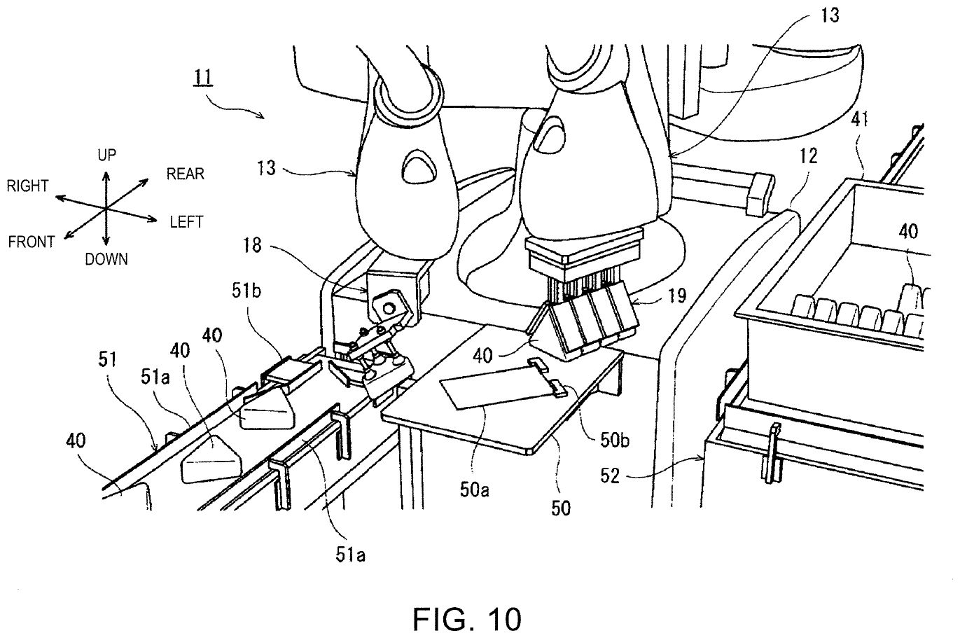

Finally, as illustrated in FIG. 10, the control device 14 controls the operation of the left arm 13 to accommodate the four pieces of food held by the left hand part 19 into the tray 41. Thus, the efficiency of the packing work of the foods 40 is improved even within the limited workspace.

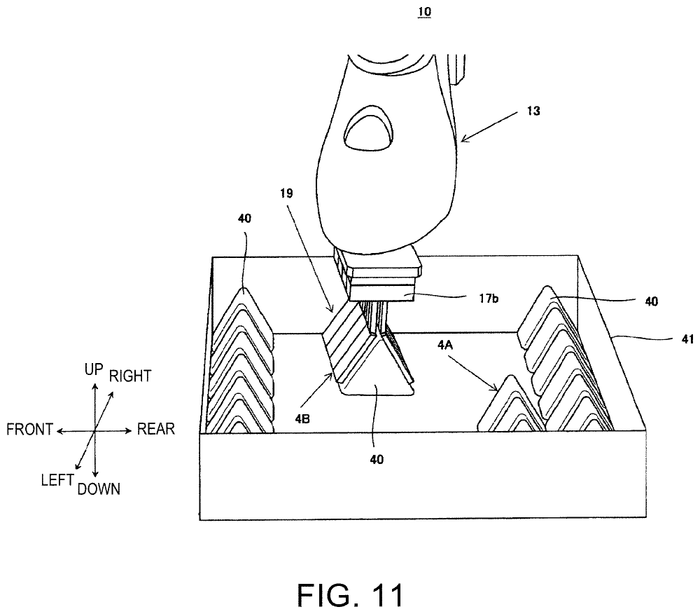

Next, with reference to FIGS. 11 to 14, one example of the packing work (operation) of the food 40 into the tray 41 by the holding device 10 according to Embodiment 1 will be described in detail.

FIGS. 11 to 14 are schematic views illustrating one example of the packing operation of the food 40 into the tray 41 by the holding device 10 of Embodiment 1. Note that, in FIGS. 11 to 14, illustration of a structure of a part of the holding device 10 is omitted.

As illustrated in FIGS. 11 to 14, one row of foods 40 is placed on each of a front end part and a rear end part of the tray 41, and four pieces of food 40 are placed in the second row of the rear end part, and in the left side part of the tray 41. Then, in the following, an operation of accommodating four pieces of food 40 held by the left hand part 19 in the second row of the rear end part, and in the right side part of the tray 41, along the second direction, will be described. Note that, in the following description, the four pieces of food 40 placed in the left side part in the second row of the rear end part of the tray 41 is referred to as a “first food group 4A,” and the four pieces of food 40 held by the left hand part 19 is referred to as a “second food group 4B.” Moreover, in FIGS. 11 to 14, the tray 41 is constructed so as to accommodate 48 pieces of food 40 (8 columns×6 rows).

As illustrated in FIG. 11, the control device 14 operates the left arm 13 so as to be located above the tray 41, and then lowers the left arm 13 so that the foods 40 gripped by the left hand part 19 at the central part of the tray 41 are located inside the tray 41. Note that the central part of the tray 41 refers to a part inward of the circumferential edge of the tray 41, and may include a part of the tray 41 where no food 40 is placed.

Subsequently, the control device 14 rotates the rotary part 17b of the left arm 13 about the rotation axis L3 so that the left hand part 19 inclines with respect to the second direction. For example, the control device 14 rotates the rotary part 17b about the rotation axis L3 so that an end of the left hand part 19 on the side closer to the first food group 4A (here, left end) approaches the first food group 4A.

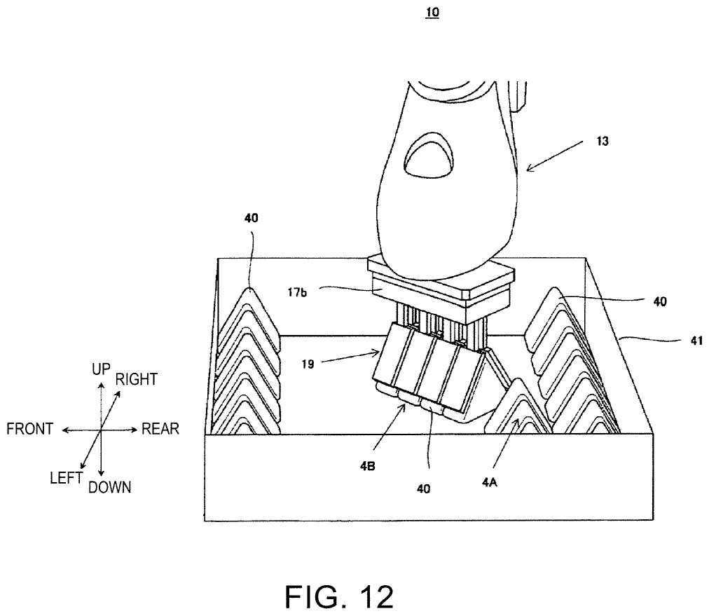

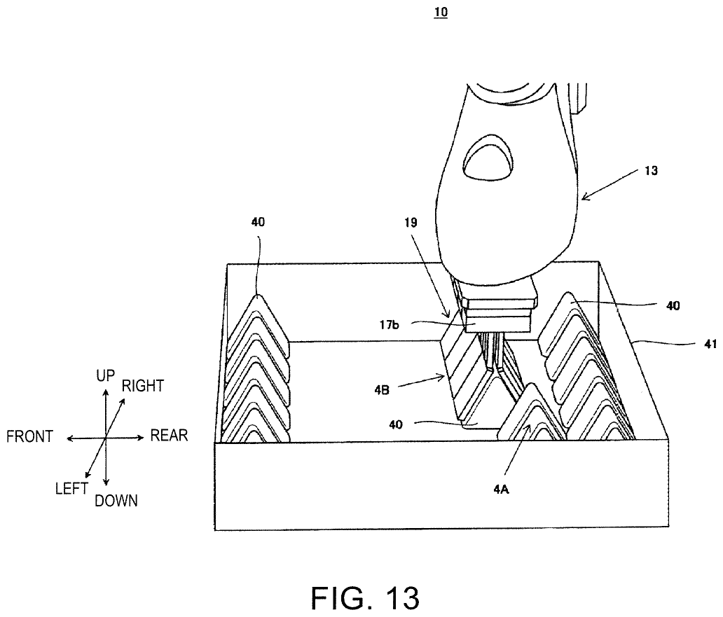

Next, as illustrated in FIG. 12, the control device 14 moves the left arm 13 in the third direction so that the left hand part 19 moves toward the rear end part of the tray 41, while being inclined with respect to the second direction. Subsequently, as illustrated in FIG. 13, when the end of the left hand part 19 moves to the back side of the first food group 4A, the control device 14 rotates the rotary part 17b about the rotation axis L3 so that the left hand part 19 becomes parallel to the second direction.

Here, the movement of the end of the left hand part 19 up to the back side of the first food group 4A may be such that at least a part of the left hand part 19 moves until it overlaps with the first food group 4A when seen in the second direction, and the overlapping degree of the first food group 4A with the left hand part 19 can be set arbitrarily.

Thus, the second food group 4B can be placed in a space of the right side part in the second row of the rear end part of the tray 41. Moreover, even if the first food group 4A placed in the left side part in the second row of the rear end part of the tray 41 sticks out into the space of the right side part, the rotary part 17b is rotated about the rotation axis L3 to bring the left hand part 19 or the foods 40 gripped by the left hand part 19 into contact with the first food group 4A, thereby pushing the first food group 4A out to the space of the left side part. Therefore, the second food group 4B can be placed in the space of the right side part.

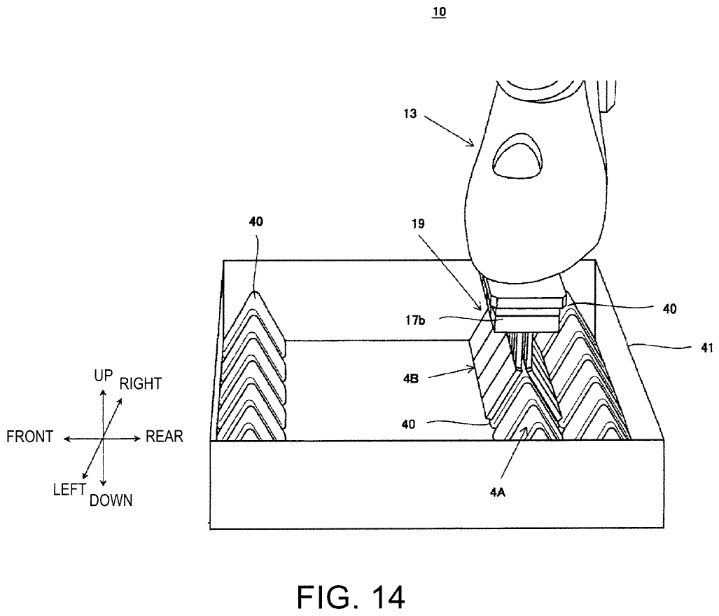

Next, as illustrated in FIG. 14, the control device 14 moves the left arm 13 in the third direction (here, rearward) so that the second food group 4B becomes adjacent in the second direction to the first food group 4A. At this time, even if the food(s) 40 adjacent to the second food group 4B (here, the food(s) 40 placed in the first row of the rear end part of the tray 41) sticks out into the right side part in the second row of the rear end part of the tray 41, the left arm 13 is moved in the third direction to bring the left hand part 19 or the foods 40 gripped by the left hand part 19 into contact with the sticking-out food 40, thereby moving the food 40 concerned to the first row.

Thus, the arm 13 can move the second food group 4B to a given position (the right side part in the second row of the rear end part of the tray 41).

Next, the control device 14 drives the actuator members 33 so that the foods 40 held by the left hand part 19 are released. Thus, the plurality of foods 40 which constitute the second food group 4B can be accommodated into the tray 41 so as to adjacent in the second direction to the first food group 4A.

Next, the control device 14 again performs the holding operation of the food 40 described above to operate the left arm 13 so that the foods 40 held by the left hand part 19 are placed in the second row on the front end side of the tray 41.

As described above, the control device 14 operates the arm 13 so as to alternately perform the accommodation at one end side (here, rear end) in the third direction of the tray 41 and the accommodation at the other end side (here, front end) in the third direction of the tray 41, to place the foods 40 inside the tray 41.

Thus, the holding device 10 of this embodiment can place the foods 40 inside the tray 41 in a state where the foods 40 are lined up.

Note that, although in Embodiment 1 the control device 14 operates the arm 13 to alternately perform the accommodation at one end side (here, the rear end) in the third direction of the tray 41 and the accommodation at the other end side (here, the front end) in the third direction of the tray 41, but it is not limited to this configuration. The control device 14 may accommodate the second food group 4B (the food 40) from the one end side toward the other end side in the third direction of the tray 41.

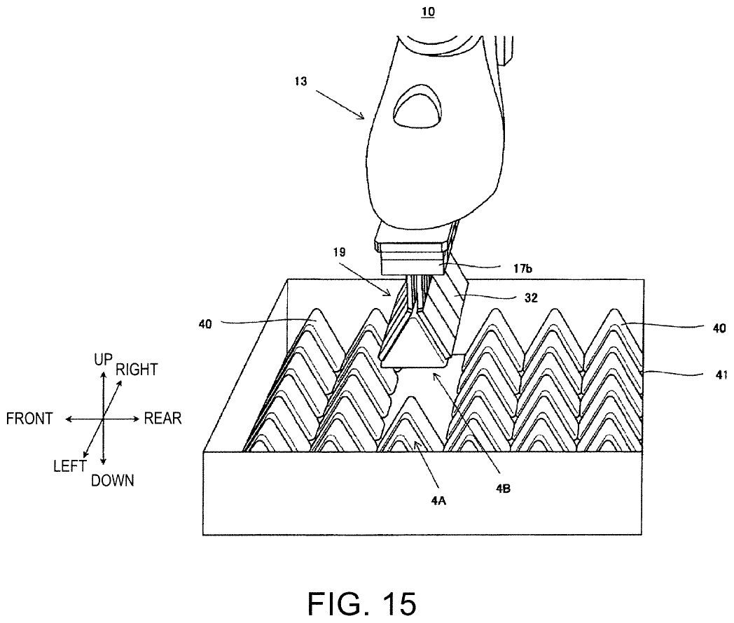

FIGS. 15 to 18 are schematic views illustrating another example of the packing operation of the foods 40 into the tray 41 by the holding device 10 in Embodiment 1. Note that, in FIGS. 15 to 18, illustration of a structure of a part of the holding device 10 is omitted.

As illustrated in FIGS. 15 to 18, three rows of foods 40 are placed in the rear end part of the tray 41, and two rows of foods 40 are placed in the front end part. Moreover, four pieces of food 40 are placed in the left side part of the tray 41 in the third row of the front end part. Then, in the following, an operation to accommodate four pieces of food 40 held by the left hand part 19 into the right side part of the tray 41 in the third row of the front end part along the second direction will be described.

Note that the following operation may be performed when the left hand part 19 releases the food 40 during the packing work (operation) of the foods 40 into the tray 41 by the holding device 10 of Embodiment 1 described above. Moreover, the following operation may be performed when accommodating, at last, four pieces of food 40 held by the left hand part 19 into the tray 41.

As illustrated in FIG. 15, the control device 14 operates the left arm 13 so that the foods 40 gripped by the left hand part 19 is located above the right side part of the third row of the front end part of the tray 41.

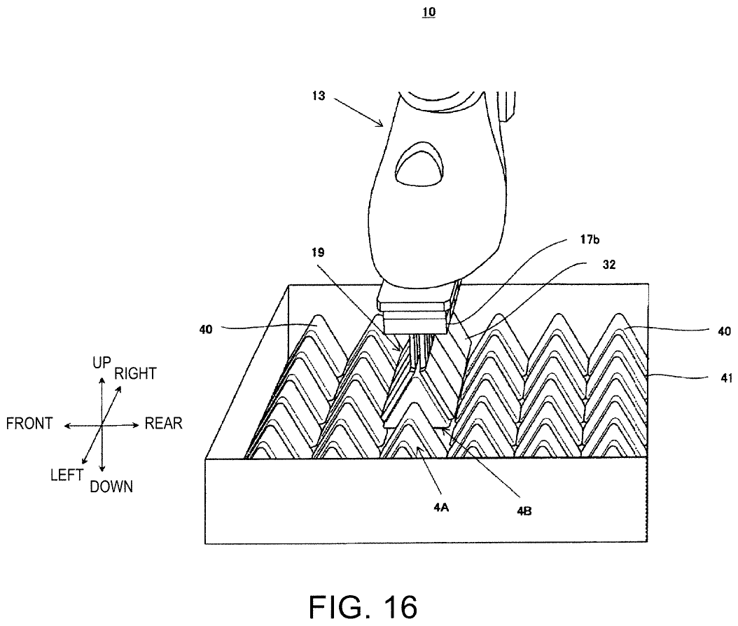

Next, as illustrated in FIG. 16, the control device 14 lowers the left arm 13 so that the foods 40 gripped by the left hand part 19 are located in a space of the right side part of the third row of the front end part of the tray 41.

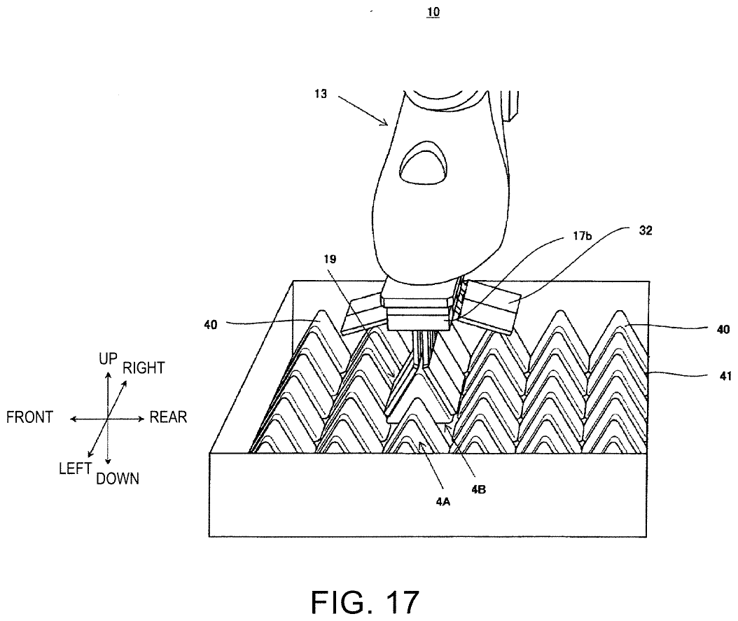

Next, as illustrated in FIG. 17, the control device 14 drives the actuator members 33 so that at least one of the foods 40 (here, two pieces of food 40 on the right side) gripped by the left hand part 19 is released. Thus, at least one of the foods 40 gripped by the left hand part 19 is placed inside the tray 41. Note that the food 40 to be released may be the food 40 in the second food group 4B, which is located nearest to the first food group 4A, or may be the food 40 located farthest from the first food group 4A.

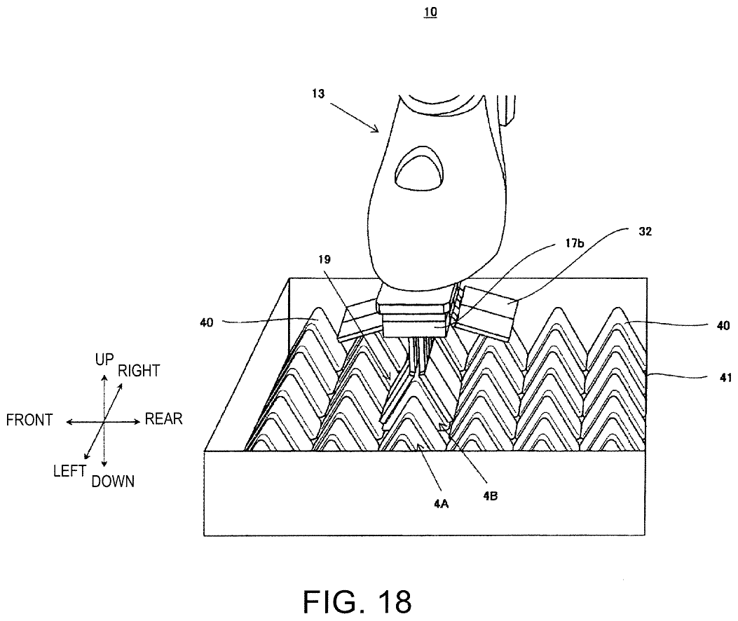

Next, as illustrated in FIG. 18, the control device 14 moves the left hand part 19 in the second direction, while the remaining foods 40 are gripped. At this time, the control device 14 may move the left hand part 19 in the second direction (here, rightward) so that the released foods 40 are separated from the first food group 4A, or may move the left hand part 19 in the second direction (here, leftward) so that the released foods 40 approach the first food group 4A. In other words, the control device 14 may move the left hand part 19 in the second direction so that a space where the remaining foods 40 gripped by the left hand part 19 are placed is secured.

Thus, by the remaining foods 40 gripped by the left hand part 19 contacting the food 40 placed inside the tray 41, the released foods 40 or the first food group 4A can be moved in the second direction. Therefore, a space of the right side part of the third row of the front end part of the tray 41 can be expanded, and a space where the remaining foods 40 gripped by the left hand part 19 are to be placed can easily be secured.

Especially, as the accommodation of the foods 40 into the tray 41 progresses, the space for accommodating the foods 40 becomes smaller, but the space for accommodating foods 40 is fully securable by the operation concerned.

Next, the control device 14 drives the actuator members 33 so that the remaining foods 40 (here, two pieces of food 40 on the left side) held by the left hand part 19 are released. Thus, the remaining foods 40 can be placed in the space of the right side part of the third row of the front end part of the tray 41.

Thus, the holding device 10 of Embodiment 1 can place the foods 40 in the lined-up state inside the tray 41.

### Embodiment 2

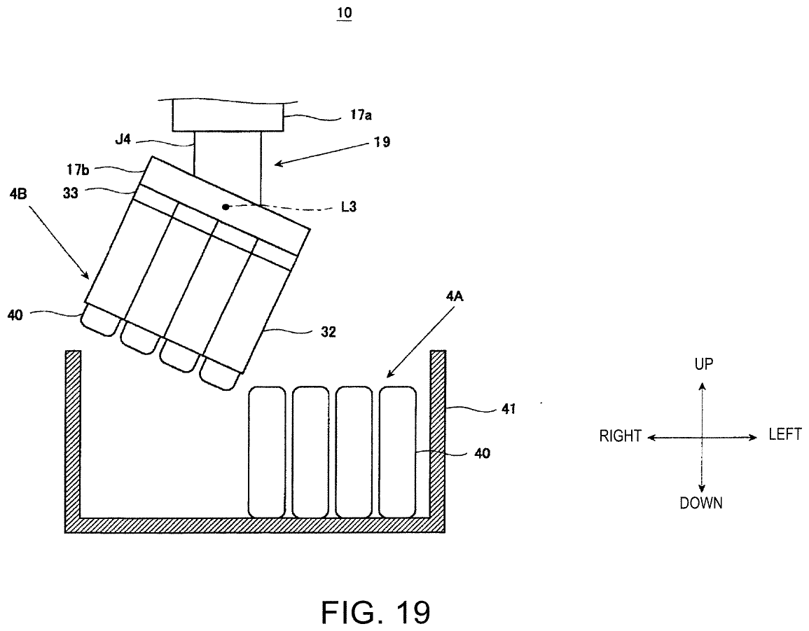

FIG. 19 is a schematic view illustrating an outline structure of a holding device of Embodiment 2, and is a schematic view illustrating one example of a packing operation into the tray. Note that, in FIG. 19, illustration of a structure of a part of the holding device 10 is omitted.

As illustrated in FIG. 19, although the fundamental structure of the holding device 10 of Embodiment 2 is the same as that of the holding device 10 of Embodiment 1 described above, it differs in that the rotation axis L3 of the left hand part 19 is oriented in the third direction (here, the front-and-rear direction). For this reason, when the left hand part 19 rotates the rotary part 17b of the left arm 13 about the rotation axis L3 so that the rotary part 17b inclines with respect to the second direction, the rotary part 17b rotates (pivots) so that one end of the left hand part 19 (here, left end) on the side closer to the first food group 4A is located below the other end of the left hand part 19 (here, right end).

The holding device 10 of Embodiment 2 constructed in this way also has similar operation and effects as the holding device 10 of Embodiment 1.

Note that, although in the holding device 10 of Embodiment 2 the rotation axis L3 of the left hand part 19 is oriented in the third direction, it is not limited to this structure.

The rotary part 17b may have two rotation axes, one of the rotation axes may be oriented in the first direction (the up-and-down direction), the other rotation axis may be oriented in the third direction, and the rotary part 17b may rotate complexly about the two rotation axes.

Alternatively, the rotary part 17b may have two rotation axes, one of the rotation axes may be oriented in the second direction (front-and-rear direction), the other rotation axis may be oriented in the third direction, and the rotary part 17b may rotate complexly about the two rotation axes.

Alternatively, the rotary part 17b may have three rotation axes, the three rotation axes may be oriented in the first to third directions, respectively, and the rotary part 17b may rotate complexly about the three rotation axes.

### Embodiment 3

A holding device of Embodiment 3 includes a holding part which holds a plurality of foods fed to a given position so as to be piled up in a given direction, a food accommodating part which accommodates the plurality of foods held by the holding part into a given container, and a controller. When an up-and-down direction of the holding device for the food is a first direction, and the given direction is a second direction, and a direction perpendicular to both the first direction and the second direction is a third direction, the controller operates the food accommodating part so that the holding part moves in the third direction, while being pivoted about the second direction, and then rotates so as to be parallel to the second direction. The controller then accommodates the second food group which is a plurality of foods held by the holding part into the given container so that the second food group is adjacent in the second direction to the first food group which is a plurality of foods accommodated in the given container.

Alternatively, in the holding device of Embodiment 1 or Embodiment 2, the controller of the holding device of Embodiment 3 may operate the food accommodating part so that the second holding part moves in the third direction, while being pivoted about the second direction, and then rotates so as to be parallel to the second direction. The controller may then accommodate the second food group which is a plurality of foods held by the second holding part into the given container so that the second food group is adjacent in the second direction to the first food group that is a plurality of foods accommodated in the given container.

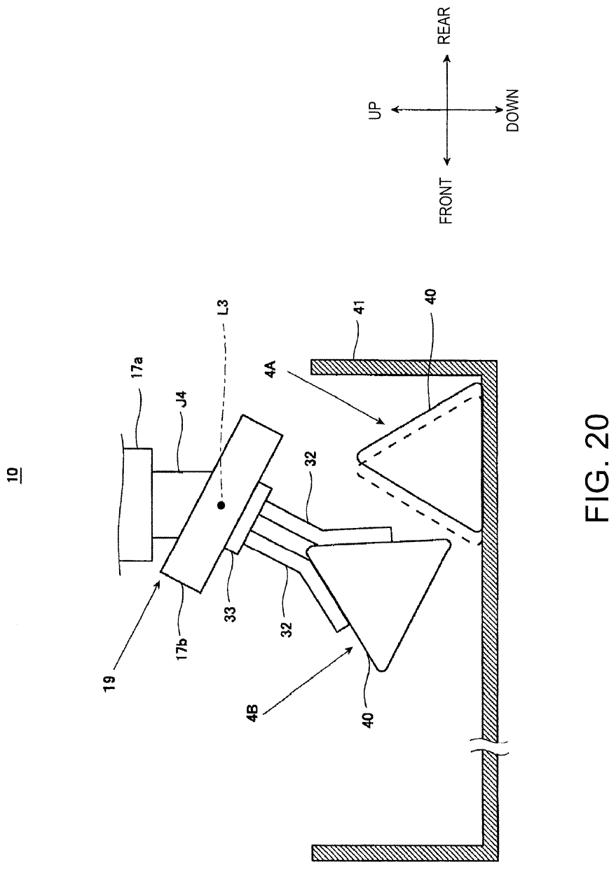

Below, one example of the holding device of Embodiment 3 will be described with reference to FIG. 20.

### [Structure of Holding Device]

FIG. 20 is a schematic view illustrating an outline structure of the holding device of Embodiment 3. Note that, in FIG. 20, illustration of a structure of a part of the holding device 10 is omitted.

As illustrated in FIG. 20, although the fundamental structure of the holding device 10 of Embodiment 3 is the same as that of the holding device 10 according to Embodiment 1, it differs in that the rotation axis L3 of the left hand part 19 is oriented in the second direction (here, the left-and-right direction).

### [Operation of Holding Device]

Next, operation of the holding device 10 of Embodiment 3 will be described with reference to FIG. 20.

First, as illustrated in FIG. 20, it is assumed that one row of foods 40 is placed in the rear end part of the tray 41, and the food 40 illustrated by a dashed line is offset toward the second row. Then, in the following, operation to place four pieces of food 40 held by the left hand part 19 into the second row of the rear end part will be described.

The control device 14 operates the left arm 13 so as to be located above the tray 41, and then lowers the left arm 13 so that the foods 40 gripped by the left hand part 19 is located inside the tray 41 at the central part of the tray 41. Subsequently, the control device 14 rotates (pivots) the rotary part 17b of the left arm 13 about the rotation axis L3 (second direction).

Next, the control device 14 moves the left arm 13 in the third direction so that the left hand part 19 moves toward the rear end part of the tray 41, while being pivoted about the second direction. Subsequently, the control device 14 rotates the rotary part 17b about the rotation axis L3 so that the left hand part 19 becomes parallel to the second direction, when one end (here, rear end) of the left hand part 19 moves near the first food group 4A of the first row.

Thus, the left hand part 19 or the foods 40 gripped by the left hand part 19 contact(s) the food(s) 40 which sticks out toward the front end to push out the food(s) 40 toward the rear end. Therefore, if the first food group 4A is not placed along the second direction, the first food group 4A can be disposed along the second direction. Moreover, the space at the given position where the second food group 4B is placed (the second row of the rear end part of the tray 41) can be secured.

Next, the control device 14 operates the left arm 13 so that the foods 40 gripped by the left hand part 19 are located at the given position (the second row of the rear end part of the tray 41). Subsequently, the control device 14 drives the actuator members 33 so that the foods 40 held by the left hand part 19 are released. Thus, the plurality of foods 40 which constitute the second food group 4B can be accommodated into the tray 41 so as to be adjacent in the second direction to the first food group 4A.

In the holding device 10 of Embodiment 3 constructed in this way, the control device 14 moves the left hand part 19 in the third direction, while the left hand part 19 is pivoted about the second direction, and then operates the left arm 13 so that the left hand part 19A is rotated to become parallel to the second direction. Even when the first food group 4A (foods 40) adjacent to the given position where the second food group 4B is placed sticks out into the given position, the foods 40 which stick out can be moved. Thus, the space at the given position where the second food group 4B is placed can be secured, and the plurality of foods 40 which constitute the second food group 4B can be accommodated into the tray 41 so as to be adjacent in the second direction to the first food group 4A.

Note that, although in the holding device 10 of Embodiment 3 the rotation axis L3 of the left hand part 19 is oriented in the second direction, it is not limited to this structure.

The rotary part 17b may have two rotation axes, one of the rotation axes may be oriented in the first direction (the up-and-down direction), the other rotation axis may be oriented in the second direction, and the rotary part 17b may rotate complexly about the two rotation axes.

Alternatively, the rotary part 17b may have two rotation axes, one of the rotation axes may be oriented in the third direction (front-and-rear direction), the other rotation axis may be oriented in the second direction, and the rotary part 17b may rotate complexly about the two rotation axes.

Alternatively, the rotary part 17b may have three rotation axes, the three rotation axes may be oriented in the first to third directions, respectively, and the rotary part 17b may rotate complexly about the three rotation axes.

### Embodiment 4

Note that in Embodiments 1-3 described above, each food 40 is sucked and held by the suction heads 22 provided to the tip-end part 21 of the right hand part 18 (see FIGS. 4A and 4B). Then, the posture of the food 40 is changed from the first posture into the second posture by rotating the tip-end part 21 via the rotary joint J5 by 90 degrees with respect to the base part 20. When sucking and holding the food 40 by the suction heads 22, a wrapping portion (first surface part 40a) of the food 40 is sucked, and the heavy main part of the food 40 is supported by the sucked wrapping portion. For this reason, when rotating the held food 40, the wrapping portion of the food 40 may be separated from the main part, which may result in the collapsing of the posture of the food 40.

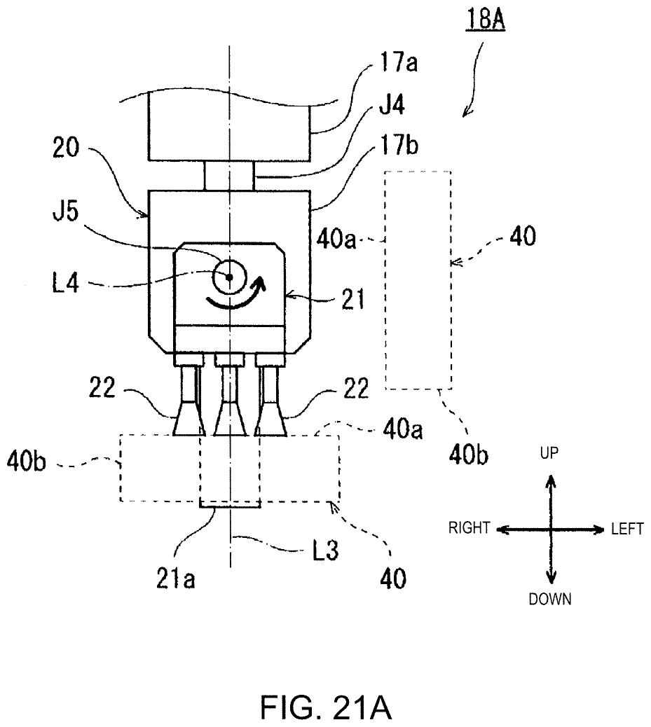

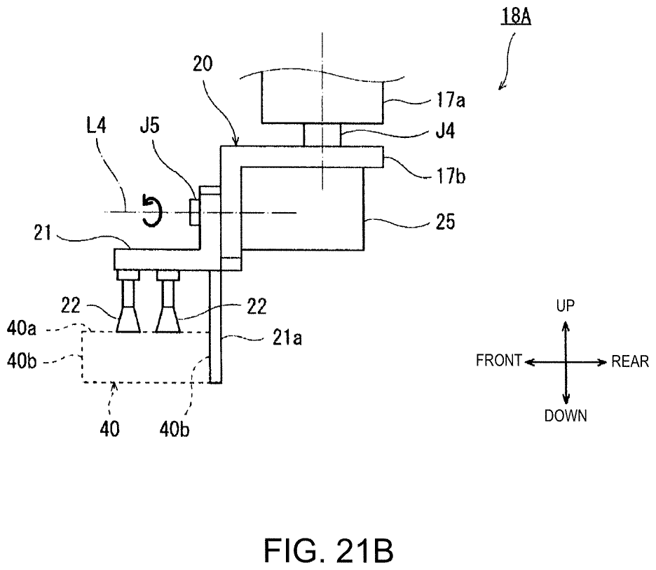

FIGS. 21A and 21B are views illustrating a structure of a right hand part 18A of Embodiment 4. As illustrated in FIGS. 21A and 21B, the right hand part 18A further has a supporting member 21a provided to the tip-end part 21. The supporting member 21a supports the food 40 which is sucked and held by the suction heads 22. Here, the wrapping portion (first surface part 40a) of the food 40 is sucked and held by the three suction heads 22. The supporting member 21a contacts the second surface part 40b of the food 40 to support it. The supporting member 21a has a flat-plate shape. The flat plate supports a part of the second surface part 40b of the food 40. Thus, since the main part of the food 40 is supported by the supporting member 21a when the food 40 sucked and held is rotated, the posture of the food 40 is stably maintained.

Note that, in Embodiment 4 described above, the control device 14 controls the actuator members 33 so that the mutual distance of the pair of holding members 32 is widened and narrowed, while keeping the mutual angle of the pair of holding members 32 at the angle (about 60 degrees) corresponding to the inclinations of the second surface parts 40b of the food 40 (see FIG. 5B). However, the control device 14 may control the actuator members 33 to change the mutual angle of the pair of holding members 32.

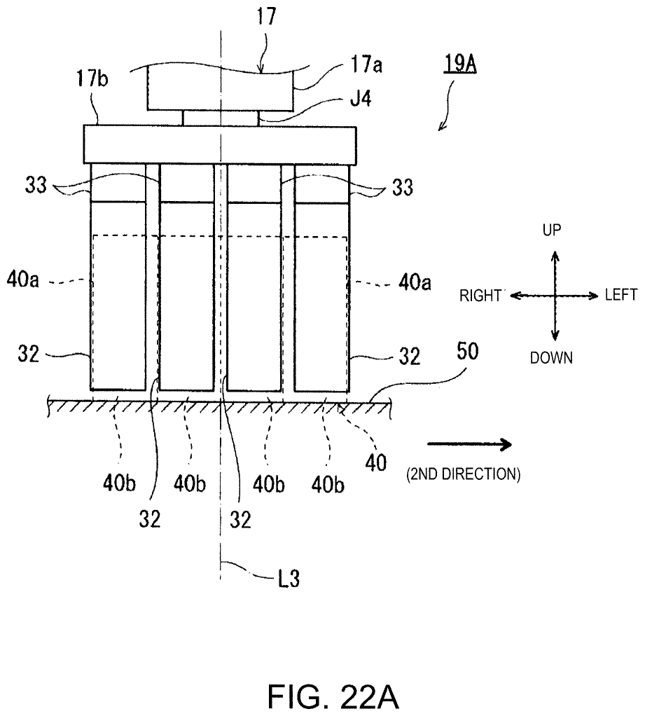

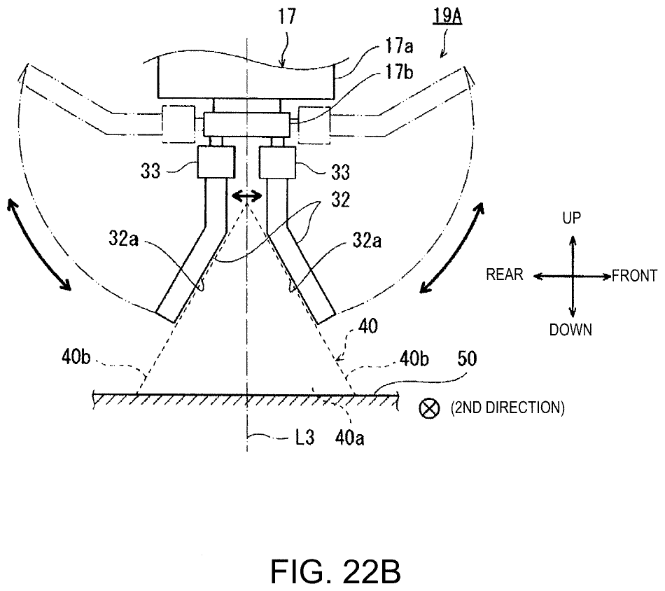

FIGS. 22A and 22B are a front view and a side view illustrating a structure of a left hand part 19A (second holding part) of Embodiment 4. As illustrated in FIG. 22B, the actuator members 33 drive the four pairs of holding members 32 so that the mutual angle of each pair of holding members 32 (contact surfaces 32a) becomes either a first angle or a second angle.

The first angle is a given mutual angle at which each pair of holding members 32 (contact surfaces 32a) can hold each food 40 by pinching the food 40 from both sides. The first angle is an angle corresponding to the inclinations of the both sides (second surface parts 40b) of the food 40, and is about 60 degrees (see FIG. 22B). Alternatively, the food 40 may be held by slightly reducing the mutual angle of each pair of holding members 32 from 60 degrees, or the food 40 may be held by slightly reducing the mutual distance of each pair of holding members 32 from the space corresponding to the inclinations of the second surface parts 40b of the food 40.

The second angle is a given mutual angle, which is 180 degrees or larger, at which each pair of holding members 32 (contact surfaces 32a) can release each food 40. Here, the second angle is 180 degrees (see FIG. 22B). Thus, it is easy to check a state of the food 40 visually or by a sensor, for example, before the holding operation of the food 40 by the left hand part 19A.

As described above, in Embodiment 4, since the opening angle of the left hand part 19A only has two values (60 degrees and 180 degrees), a complicated control is not required.

Meanwhile, after the left hand part 19A accommodates the four pieces of food held into the tray 41, the left hand part 19 must be controlled to cancel the holding operation of the four pieces of food 40 and then immediately evacuate from the tray 41. Each actuator member 33 of the left hand part 19 drives the pair of holding members 32 based on the control command (the release command or hold command) from the control device 14.

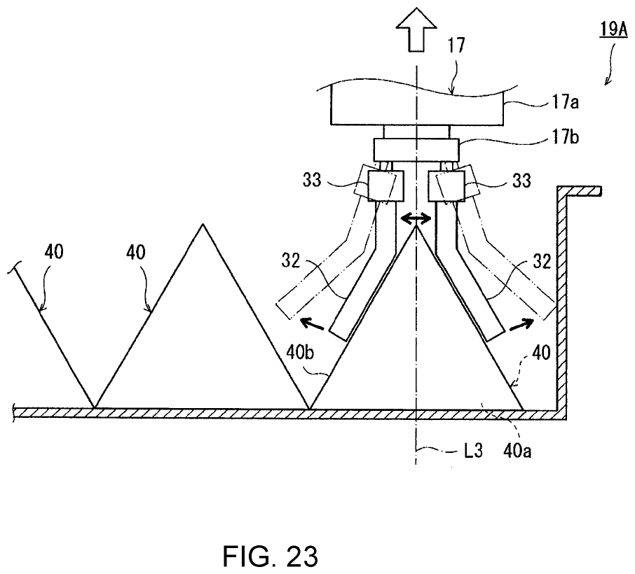

FIG. 23 is a view illustrating the evacuation operation of the left hand part 19A of FIGS. 22A and 22B.

As illustrated in FIG. 23, when the left hand part 19A opens 90 degrees or more inside the tray 41, the holding member 31 collides with the inner wall of the tray 41 or the adjacent food 40. Below, the angle (90 degrees) at which the collision occurs may also be referred to as a “third angle.” Since the opening angle of the left hand part 19A is controlled to either 180 degrees or 60 degrees, the collision occurs if the holding operation (180 degrees) of the left hand part 19 is completely canceled inside the tray 41.

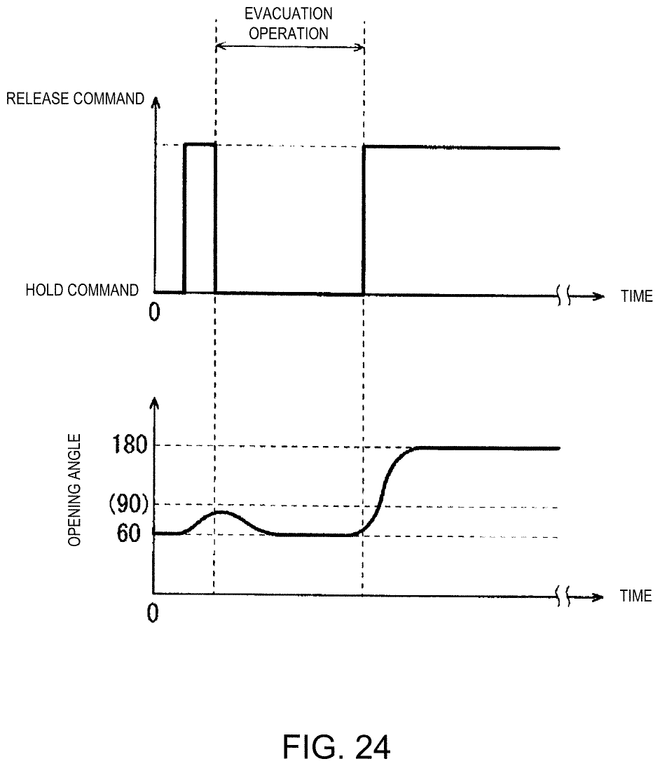

Thus, the control device 14 controls the timing of outputting the control command for the evacuation operation of the left hand part 19A. Here, the timing of outputting the control command for the left hand part 19A during the evacuation operation will be described with reference to FIG. 24.

FIG. 24 is a timing chart illustrating one example of the control command and the angle of the left hand part 19A for the evacuation operation.

As illustrated in FIG. 24, the control device 14 first switches the output from the hold command to the release command prior to the evacuation operation of the left hand part 19A. The release command is outputted for a short period of time (e.g., 0.1 seconds). The output is then switched to the hold command, and this command is kept for a given period of time (0.5 seconds). That is, the output is switched from the release command to the hold command at a timing where the mutual angle of each pair of holding members 32 does not exceed the third angle (90 degrees) which is larger than the first angle (60 degrees) and smaller than the second angle (180 degrees). Here, the angle of the holding members 32 is increased (e.g., about 60 degrees plus 10 degrees) only for the short period of time to cancel the holding operation. The angle of the holding members 32 is again decreased while the hold command is maintained, and is then returned to 60 degrees. In the meantime, the control device 14 controls the operation of the left arm 13 to perform the evacuation operation of the left hand part 19A (evacuation command) After the left hand part 19A moves above the height of the tray 41, the control device 14 again outputs the release signal to cancel the holding operation completely (180 degrees). Thus, the evacuation operation of the left hand part 19A is finished.

Thus, when evacuating the left hand part 19A out of the tray 41, the control device 14 can control the opening angle of the left hand part 19A to be smaller than the third angle (90 degrees), by controlling the output timing of the control command to the actuator members 33. Thus, during the evacuation operation of the left hand part 19A, it can be avoided that the holding member 32 collides with the inner wall of the tray 41 or the adjacent food 40. Note that, although the first angle is set as about 60 degrees, it is not limited to this angle, as long as it is a given angle at which the food 40 can be held. Although the second angle is set as 180 degrees, it is not limited to this angle, as long as it is a given angle of 180 degrees or larger at which the food 40 can be released. Moreover, although the third angle is set as 90 degrees, it is not limited to this angle, as long as it is a given angle larger than the first angle and smaller than the second angle.

Note that in Embodiments 1-3 the control device 14 controls the operation of the right arm 13 to feed the foods 40 held in the second posture by the right hand part 18 to the position on the sheet 50a placed on the workbench 50 (see FIG. 8). By repeating the above operation, four pieces of food 40 are sequentially fed to the positions on the sheet 50a placed on the workbench 50. In order to stabilize the posture of the food 40 (second posture) on the sheet 50a, a cross-sectional shape of the sheet 50a has the following features.

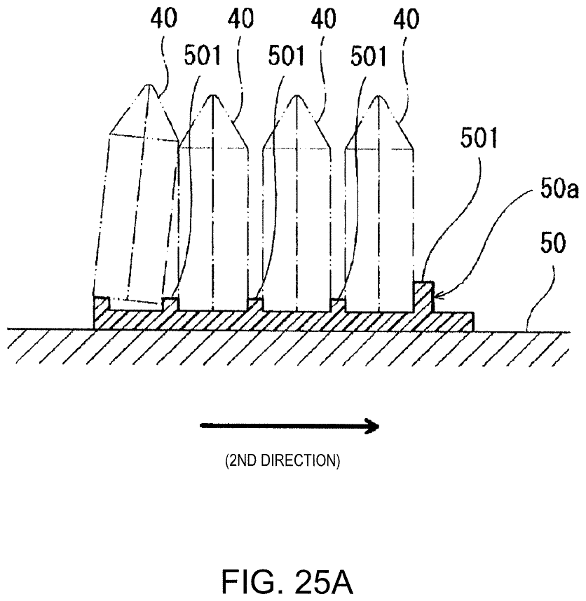

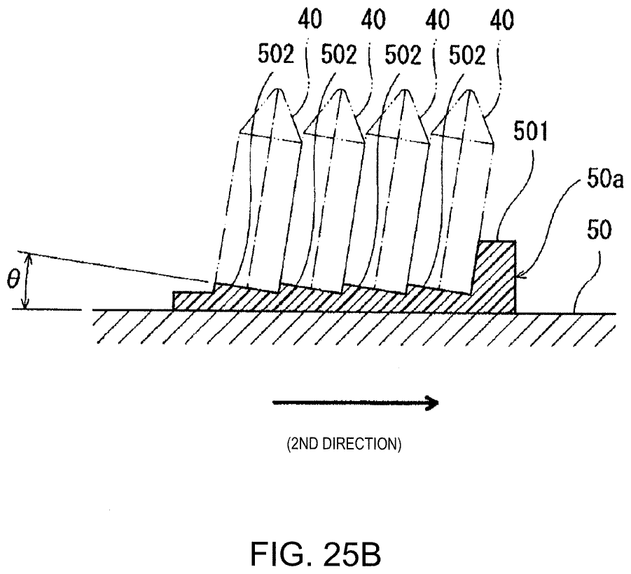

FIG. 25A illustrates one example of the cross-sectional view of the sheet 50a in the second direction.

As illustrated in FIG. 25A, the sheet 50a has a plurality of convex parts 501 lined up in the second direction in the cross-sectional view in the second direction. The material of the sheet 50a may be, but not limited to, synthetic resin, such as plastic. In the cross-sectional view, the convex parts 501 are lined up in the second direction so that the respective four pieces of food 40 lined up in the second direction are supported in the second posture. In this embodiment, five convex parts 501 are provided. Four pieces of food 40 are accommodated in the spaces between the five convex parts 501. The forwardmost food 40 among the four pieces of food 40 tends to be applied to the largest load in the second direction. For this reason, the convex part 501 for supporting the forwardmost food 40 is made taller than other convex parts 501. By having the plurality of convex parts 501, the posture of each food 40 (second posture) on the sheet 50a can be stabilized. Therefore, it is easier to hold the four pieces of food 40 in the laterally piled-up manner in the second direction by the left hand part 19A.

FIG. 25B illustrates a cross-sectional view of another example of the sheet 50a.

As illustrated in FIG. 25B, the sheet 50a has a plurality of steps 502 lined up in the second direction in the cross-sectional view in the first direction. The steps 502 are provided so as to incline in the second direction the four pieces of food 40 lined up in the second direction, while supporting the respective four pieces of food 40 in the second posture. In this embodiment, four steps 502 are provided. An inclination angle θ is 7 degrees with respect to the second direction. Although four pieces of food 40 are disposed on the respective four steps 502, the forwardmost food 40 is applied to a load in the second direction because each step 502 is inclined. For this reason, the convex part 501 for supporting the forwardmost food 40 is provided. By having the plurality of steps 502, the posture of each food 40 (second posture) on the sheet 50a can be stabilized. Therefore, it is easier to hold the four pieces of food 40 in the laterally piled-up manner in the second direction by the left hand part 19A.

Moreover, although in Embodiments 1-3 the right hand part 18 is structured to suck and hold the food 40 by the suction heads 22, other structure may be possible as long as it can hold the food 40 in the first posture. For example, the right hand part 18 may be structured to hold the structure the food 40 by a chuck device.

FIG. 26 is a plan view illustrating another structure of the right hand part 18B.

As illustrated in FIG. 26, the right hand part 18B includes a chuck body (not illustrated), and three chuck members 26 disposed on the chuck body so as to be separated from each other and holding the food 40. The right hand part 18B is constructed to hold the food 40 by moving the chuck members 26 radially inwardly from outward with respect to a center axis C of the food 40 disposed at the given position (arrow direction in the figure).

Note that although in Embodiments 1-4 the left hand parts 19 and 19A each is constructed to have the four pairs of holding members 32 lined up in the second direction, and the four actuator members 33 capable of independently driving the respective four pairs of holding members 32, to hold the respective four pieces of food 40, the left hand parts 19 and 19A each may be constructed to collectively hold the four pieces of food 40 by a pair of holding members. In this case, the pair of holding members may be constructed to cover the side surfaces of the four pieces of food 40 laterally piled up in the second direction.

Note that, although in Embodiments 1-4 the left hand parts 19 and 19A each is structured to collectively hold the four pieces of food 40, the number of holding members 32 lined up in the second direction may be changed to hold two pieces or three pieces of food 40, or hold five or more pieces food 40.

Note that, although in Embodiments 1-4 the food 40 is the triangular pillar-shaped object (triangular rice ball), it is not limited to this shape, and may be a circular cylindrical object (round rice ball), or may be a flat shape.

Note that, although in Embodiments 1-4 the holding device 10 for the food 40 is used for the packing work of the plurality of foods 40 into the tray 41, it may be applied to other works which require holding of a plurality of foods 40.

It is apparent for a person skilled in the art that many improvements and other embodiments of the present disclosure are possible from the above description. Therefore, the above description is to be interpreted only as illustration, and it is provided in order to teach a person skilled in the art the best mode which implements the present disclosure. The details of the structures and/or the functions may substantially be changed, without departing from the spirit of the present disclosure.

### INDUSTRIAL APPLICABILITY

The present disclosure is useful as the holding device for food when packing the food into the tray.

### DESCRIPTION OF REFERENCE CHARACTERS

10 Holding Device
11 Robot
13 Right Arm (Food Feeding Part)
13 Left Arm (Food Accommodating Part)
14 Control Device
17 Wrist Part
18 Right Hand Part (First Holding Part)
19 Left Hand Part (Second Holding Part)
20 Base Part
21 Tip-end Part
22 Suction Head
25 Actuator
26 Chuck Member
32 Holding Member
33 Actuator Member
40 Food
41 Tray
50 Workbench
51 First Belt Conveyor
52 Second Belt Conveyor

1. A holding device for food, comprising:
a first holding part configured to hold the food in a first posture where a given first surface of the food is oriented horizontally, and to be changeable the posture of the food from the first posture into a second posture where a second surface different from the first surface of the food is oriented horizontally;
a food feeding part configured to sequentially feed the food held in the second posture to a given position by the first holding part;
a second holding part configured to hold a plurality of foods fed to the given position in the second posture, the foods being held so as to be laterally piled up in a given direction; and
a food accommodating part configured to accommodate the plurality of foods held by the second holding part into a given container.

2. The holding device of claim 1, wherein the first holding part includes:
a base part;
a rotary joint having a horizontal rotation axis;
a tip-end part rotatably coupled to the base part via the rotary joint; and
one or more holding heads, provided to the tip-end part and configured to hold the food.

3. The holding device of claim 2, wherein the holding head is a suction head configured to suck and hold the first surface of the food, and
wherein the first holding part further includes a support member, provided to the tip-end part, and configured to support the food sucked by the suction head by contacting the second surface of the food.

4. The holding device of claim 1, wherein the second holding part has a plurality of pairs of holding members configured to hold the respective foods laterally piled up in the second posture at the given position.

5. The holding device of claim 4, wherein the second holding part further has actuator members configured to drive the respective pairs of holding members so that a mutual angle of each of the pairs of holding members becomes one of a given first angle at which the pair of holding members are holdable of the food by pinching the food from both sides, and a given second angle that is 180 degrees or larger, at which the pair of holding members are releasable of the food.

6. The holding device of claim 5, further comprising a controller configured to output a hold command or a release command to be the first angle or the second angle to the actuator member,
wherein, when evacuating the second holding part which accommodated the plurality of food in the given container out of the given container, the controller switches the output from the hold command to the release command, and switches the output from the release command to the hold command at a timing where the mutual angle of the pair of holding members is larger than the first angle, and does not exceed a third given angle smaller than the second angle.

7. The holding device of claim 1, further comprising a sheet disposed at the given position,
wherein the sheet has convex parts lined up in the given direction, in a cross-sectional view in the given direction, so as to support the respective foods lined up in the given direction in the second posture.

8. The holding device of claim 1, further comprising a sheet disposed at the given position,
wherein the sheet has steps provided, in a cross-sectional view in the given direction, so as to incline the foods in the given direction, while supporting the respective foods lined up in the given direction in the second posture.

9. The holding device of claim 1, wherein the food has the first surface and a second surface perpendicular to the first surface, and
wherein the first posture is a posture in which the first surface of the food is oriented downwardly, and the second posture is a posture in which the second surface of the food is oriented downwardly.

10. The holding device of claim 1, comprised of a robot having:
a first arm having the first holding part at a tip end thereof; and
a second arm having the second holding part at a tip end thereof.

11. The holding device of claim 1, further comprising a controller,
wherein, when an up-and-down direction of the holding device is defined as a first direction, the given direction is defined as a second direction, and a direction perpendicular to both the first direction and the second direction is defined as a third direction, the controller operates the food accommodating part to move the second holding part in the third direction, while inclining the second holding part with respect to the second direction, then rotate the second holding part so that the second holding part becomes parallel to the second direction, and accommodate a second food group that is a plurality of foods held by the second holding part into the given container so as to be adjacent in the second direction to a first food group that is a plurality of foods accommodated in the given container.

12. The holding device of claim 1, further comprising a controller,
wherein, when an up-and-down direction of the holding device is defined as a first direction, the given direction is defined as a second direction, and a direction perpendicular to both the first direction and the second direction is defined as a third direction, the controller operates the food accommodating part to move the second holding part in the third direction, while pivoting the second holding part about the second direction, then rotate the second holding part so that the second holding part becomes parallel to the second direction, and accommodate a second food group that is a plurality of foods held by the second holding part into the given container so as to be adjacent in the second direction to a first food group that is a plurality of foods accommodated in the given container.

13. The holding device of claim 11, wherein the controller operates the food accommodating part to rotate the second holding part so as to become parallel to the second direction, then move the second holding part in the third direction, and accommodate the second food group into the given container so as to be adjacent in the second direction to the first food group.

14. The holding device of claim 11, wherein the controller operates the food accommodating part to accommodate the second food group into the given container on one end side in the third direction so as to be adjacent in the second direction to the first food group, and then accommodate the second food group into the given container on the other end side in the third direction.

15. The holding device of claim 14, wherein the controller operates the food accommodating part to alternately perform the accommodation into the given container at the one end side in the third direction and the accommodation into the given container at the other end side in the third direction.

16. The holding device of claim 11, wherein the controller operates the food accommodating part to accommodate the second food group into the given container from the one end side to the other end side in the third direction.

17. The holding device of claim 11, wherein, when the up-and-down direction of the holding device is defined as the first direction, the given direction is defined as the second direction, and the direction perpendicular to both the first direction and the second direction is defined as the third direction, the controller operates the food accommodating part to release the holding of at least one food of the second food group that is a plurality of foods held by the second holding part, then move the second holding part in the second direction, then release the holding of the remaining food held by the second holding part, and accommodate the second food group into the given container so as to be adjacent in the second direction to the first food group that is a plurality of foods accommodated in the given container.

18. The holding device of claim 17, wherein the controller operates the food accommodating part to move the second holding part in the second direction so that the released food is separated from the first food group.

19. A holding device for food, comprising:
a holding part configured to hold a plurality of foods fed to a given position so as to be laterally piled up in a given direction;
a food accommodating part configured to accommodate the plurality of foods held by the holding part into a given container; and
a controller,
wherein, when an up-and-down direction of the holding device is defined as a first direction, the given direction is defined as a second direction, and a direction perpendicular to both the first direction and the second direction is defined as a third direction, the controller operates the food accommodating part to move the holding part in the third direction, while inclining the holding part with respect to the second direction, then rotate the holding part so as to be parallel to the second direction, and accommodate a second food group that is a plurality of foods held by the holding part into the given container so as to be adjacent in the second direction to a first food group that is a plurality of foods accommodated in the given container.

20. A holding device for food, comprising:
a holding part configured to hold a plurality of foods fed to a given position so as to be laterally piled up in a given direction;
a food accommodating part configured to accommodate the plurality of foods held by the holding part into a given container; and
a controller,
wherein, when an up-and-down direction of the holding device is defined as a first direction, the given direction is defined as a second direction, and a direction perpendicular to both the first direction and the second direction is defined as a third direction, the controller operates the food accommodating part to move the holding part in the third direction, while pivoting the holding part about the second direction, then rotate the holding part so as to be parallel to the second direction, and accommodate a second food group that is a plurality of foods held by the holding part into the given container so as to be adjacent in the second direction to a first food group that is a plurality of foods accommodated in the given container.

21. The holding device of claim 19, wherein the controller operates the food accommodating part to rotate the holding part so as to be parallel to the second direction, then move the holding part in the third direction, and accommodate the second food group into the given container so as to be adjacent in the second direction to the first food group.

22. The holding device of claim 19, wherein the controller operates the food accommodating part to accommodate the second food group into the given container on one end side in the third direction so as to be adjacent in the second direction to the first food group, and then accommodate the second food group into the given container on the other end side in the third direction.

23. The holding device of claim 22, wherein the controller operates the food accommodating part to alternately perform the accommodation into the given container at the one end side in the third direction and the accommodation into the given container at the other end side in the third direction.

24. The holding device of claim 19, wherein the controller operates the food accommodating part to accommodate the second food group into the given container from the one end side to the other end side in the third direction.

25. The holding device of claim 19, wherein the holding part has a plurality of pairs of holding members configured to hold the respective foods,
wherein, when an up-and-down direction of the holding device is defined as a first direction, the given direction is defined as a second direction, and a direction perpendicular to both the first direction and the second direction is defined as a third direction, the controller operates the food accommodating part to release the holding of at least one food of the second food group that is a plurality of foods held by the holding part, then move the holding part in the second direction, then release the holding of the remaining food held by the holding part, and accommodate the second food group into the given container so as to be adjacent in the second direction to the first food group that is a plurality of foods accommodated in the given container.

26. The holding device of claim 25, wherein the controller operates the food accommodating part to move the holding part in the second direction so that the released food is separated from the first food group.
